(19) United States
(12) Patent Application Publication
(10) Pub. No.: US 2004/0098304 A1
(43) Pub. Date: May 20, 2004

(54) System and method for issuing coupons

(75) Inventors: Marie-Anne Truong, Milpitas, CA (US); Bhamini Desai, Milpitas, CA (US); Roland Franz Oberdorfer, Mountain View, CA (US)

Correspondence Address: HEWLETT-PACKARD COMPANY, Intellectual Property Administration, P.O. Box 272400, Fort Collins, CO, 80527-2400, US

(73) Assignee: Hewlett-Packard Company, Fort Collins, CO

(21) Appl. No.: 10/298,699

(22) Filed: Nov. 18, 2002

(51) Int. Cl. G06F 17/60

(52) U.S. Cl. 705/14

(57) ABSTRACT

A system and method for issuing coupons for a campaign in an electronic commerce environment. Coupon-issuing information in entered into exposed fields, and a determination is subsequently made if the fields have specified coupon-issuing information. Coupons are issued based on the coupon-issuing information specified in the fields. A campaign may be issued for the product by determining the type of distribution for a product, and specifying an identification and a priority of the product.

### BACKGROUND OF THE INVENTION

1. Field of the Invention

Embodiments of the present invention relate generally to an electronic commerce environment. More particularly, embodiments of the present invention relate to a system and method for creating a campaign in an electronic commerce environment. Other embodiments of the present invention also relate to systems and methods for the redemption of coupons and for the distribution of coupons.

2. Description of the Background Art

In an electronic commerce environment there is a desire to increase customer satisfaction by having the capability to distribute coupons. However, there is also the desire to ensure that any given coupon is only used once and by the entitled customer. Therefore, it would be useful to have a system and method that provides for the distribution of coupons to eligible customers, that enforces the use of the coupon to only a single time, and that restricts the use of the coupon to only those customers who are qualified through a suitable campaign, such as a promotion. Such a system and method will be able to transmit electronic commerce offers to targeted potential customers for the acquisition of new customers while simultaneously maintaining good relations with an existing customer base.

### SUMMARY OF EMBODIMENTS OF THE INVENTION

Embodiments of the present invention provide a method for creating a campaign for a product comprising determining that a type of distribution for at least one product is a gift with purchase type of distribution, specifying an identification for the product, and specifying a priority for the product for creating a campaign for the product. A campaign name for the product may be specified prior to determining the type of distribution for the product. The method additionally comprises replicating coupons from a created base coupon, and tagging the product. In an embodiment of the invention, tagging the product comprises selecting a product type, specifying a price range limit on the product, specifying that the product is a storewide product or a category wise product, determining if the product is an online product, and determining if the campaign applies to a bundle. The campaign may be invalidated, such as by specifying the name of the campaign for invalidation, and determining if the coupons are successfully turned off-line.

Additional embodiments of the present invention include a method for creating a campaign for a product comprising specifying information in exposed fields, determining that all fields have specified information, determining a type of distribution for a product, and creating a campaign based on the information specified in the fields. The type of distribution may be one selected from the group consisting of a third party type of distribution, a customer satisfaction type of distribution, and a gift with purchase type of distribution. If the type of distribution comprises a gift with purchase type of distribution, the method may additionally comprise determining if a product ID has been assigned to a product ID field, and determining if a priority has been assigned to a priority field. A determination may be made as to whether or not the campaign was properly and/or successfully created.

Additional embodiments of the present invention provide a system for creating a campaign for a product comprising means for determining that a type of distribution for at least one product is a gift with purchase type of distribution, means for receiving a specified identification for the product, and means for receiving a specified priority for the product to create a campaign for the product. In another embodiment a system for creating a campaign comprises means for receiving specified information in exposed fields, means for determining that all fields have specified information, means for determining a type of distribution for a product, and means for creating a campaign based on the information specified in the fields.

Embodiments of the present invention also provide a system and method for issuing coupons for a campaign. The method comprises entering coupon-issuing information into exposed fields, determining that the fields have specified coupon-issuing information, and issuing coupons based on the coupon-issuing information specified in the fields. The method may additionally comprise determining a role of a person requesting the issuance of coupons. The coupon-issuing information comprises one or more information selected from the group consisting of agent ID, reason for issuing coupons, issue date, order number, and E-mail address of person to whom agent issued coupon. The method may further additionally comprise re-issuing coupons, determining if the coupons are available for a campaign, recording a coupon-issuing entry into a database, returning a coupon code and a coupon description.

Further embodiments of the present invention provide a computer-readable storage medium storing program code for causing a computer to perform the steps of determining that a type of distribution for at least one product is a gift with purchase type of distribution, receiving a specified identification for the product, and receiving a specified priority for the product to create a campaign for the product. In another embodiment there is provided a computer-readable storage medium storing program code for causing a computer to perform the steps of receiving specified information in exposed fields, determining that all fields have specified information, determining a type of distribution for a product, and creating a campaign based on the information specified in the fields.

Features of further embodiments of the present invention provide a system and a method for redeeming a coupon. The method comprises determining that a coupon is valid, determining that the valid coupon is still available for use, and determining that the available valid coupon is tied to a user. The method further comprises determining that an ID for the user matches an ID for the user stored for the available valid coupon, and adding the available valid coupon to an order by the user to redeem the coupon. The method may also further comprise determining that the order contains a single use coupon, determining that the order has been approved, and tying the ID of the user to the coupon to prevent the user from using the coupon again.

The system for redeeming a coupon broadly comprises: means for determining that a coupon is valid, means for determining that the valid coupon is still available for use, means for determining that the available valid coupon is tied to a user, means for determining that an ID for the user matches an ID for the user stored for the available valid coupon, and means for adding the available valid coupon to an order by the user to redeem the coupon. The system for redeeming a coupon may further broadly comprise means for determining that the order contains a single use coupon, means for determining that the order has been approved, and means for tying the ID of the user to the coupon to prevent the user from using the coupon again.

These provisions together with the various ancillary provisions and features which will become apparent to those artisans possessing skill in the art as the following description proceeds are attained by devices, assemblies, systems and methods of embodiments of the present invention, various embodiments thereof being shown with reference to the accompanying drawings, by way of example only, wherein:

### BRIEF DESCRIPTION OF THE DRAWINGS

FIG. 1 is a schematic block diagram that exemplarily illustrates a computer system which may be employed for various embodiments of the present invention.

FIG. 2 is a functional diagram illustrating a computer network where embodiments of the present invention may be employed.

FIG. 3 illustrates a schematic diagram of a system for creating and publishing web pages which may be employed for various embodiments of the present invention.

FIG. 4 is a schematic diagram of a coupon administrator tool employed for creating a campaign, tagging a product, creating a base coupon, replicating a coupon, and invalidating a coupon.

FIG. 5A is an elevational view of a screen or monitor illustrating various fields for creating a campaign.

FIG. 5B is an elevational view of the screen or monitor of FIG. 5A displaying a message that a campaign was successfully created and has an ID of “362”.

FIG. 5C is a schematic flow diagram of logic employed by a computer system for creating a campaign.

FIG. 6A is an elevational view of a screen or monitor displaying various fields at least of portion of which contains appropriate information for tagging a product.

FIG. 6B is an elevational view of the screen or monitor of FIG. 6A displaying a message that a coupon/campaign has been successfully tagged.

FIG. 6C is a schematic flow diagram of logic employed by a computer system for tagging a campaign/coupon to storewide products or category wise products.

FIG. 7A is an elevational view of a screen or monitor displaying various incentive fields including an incentive type field to indicate which type of incentive (e.g., sale or coupon, etc) an end user wishes to create.

FIG. 7B is an elevational view of a screen or monitor displaying an incentive date field.

FIG. 7C is an elevational view of a screen or monitor displaying an incentive-coupon details field.

FIG. 7D is an elevational view of a screen or monitor displaying an incentive select product field.

FIG. 7E is an elevational view of a screen or monitor displaying an incentive price-adjustment field.

FIG. 7F is an elevational view of a screen or monitor displaying an incentive option field for creating a base coupon.

FIG. 7G is an elevational view of a screen or monitor displaying a field for assigning a selected campaign into product tagger after creation of base coupon.

FIG. 8A is an elevational view of a screen or monitor illustrating various fields for replicating a base coupon.

FIG. 8B is an elevational view of the screen or monitor of FIG. 8A after a campaign name and the number of coupons have been inserted into appropriate respective fields for replicating coupons.

FIG. 8C is a schematic flow diagram of logic employed by a computer system for replicating or creating coupons.

FIG. 9A is an elevational view of a screen or monitor illustrating a field for invalidating a campaign.

FIG. 9B is an elevational view of the screen or monitor of FIG. 9A after a campaign name has been inserted into the appropriate field for invalidating a campaign.

FIG. 9C is an elevational view of the screen or monitor of FIG. 9B displaying a message that a campaign (i.e., a campaign with ID 241) has been successfully invalidated.

FIG. 9D is a schematic flow diagram of logic employed by a computer system for invalidating a campaign and turning coupons off-line.

FIG. 10 is a schematic flow diagram of logic employed by a computer system for issuing coupons.

FIG. 11 is a schematic flow diagram of logic employed by a computer system for redeeming coupons.

FIG. 12 is a schematic flow diagram of logic employed by a computer system for archiving coupons.

FIG. 13 is a schematic flow diagram of another embodiment of the logic employed by a computer system for replicating coupons.

### DETAILED DESCRIPTION OF EMBODIMENTS OF THE INVENTION

In the description herein, numerous specific details are provided, such as examples of components and/or methods, to provide a thorough understanding of embodiments of the present invention. One skilled in the relevant art will recognize, however, that an embodiment of the invention can be practiced without one or more of the specific details, or with other apparatus, systems, assemblies, methods, components, materials, parts, and/or the like. In other instances, well-known structures, materials, or operations are not specifically shown or described in detail to avoid obscuring aspects of embodiments of the present invention.

A “computer” for purposes of embodiments of the present invention may be any processor-containing device, such as a mainframe computer, a personal computer, a laptop, a notebook, a microcomputer, a server, or any of the like. A “computer program” may be any suitable program or sequence of coded instructions which are to be inserted into a computer, well know to those skilled in the art. Stated more specifically, a computer program is an organized list of instructions that, when executed, causes the computer to behave in a predetermined manner. A computer program contains a list of ingredients (called variables) and a list of directions (called statements) that tell the computer what to do with the variables. The variables may represent numeric data, text, or graphical images.

A “computer-readable medium” for purposes of embodiments of the present invention may be any medium that can contain, store, communicate, propagate, or transport the program for use by or in connection with the instruction execution system, apparatus, system or device. The computer readable medium can be, by way of example only but not by limitation, an electronic, magnetic, optical, electromagnetic, infrared, or semiconductor system, apparatus, system, device, propagation medium, or computer memory.

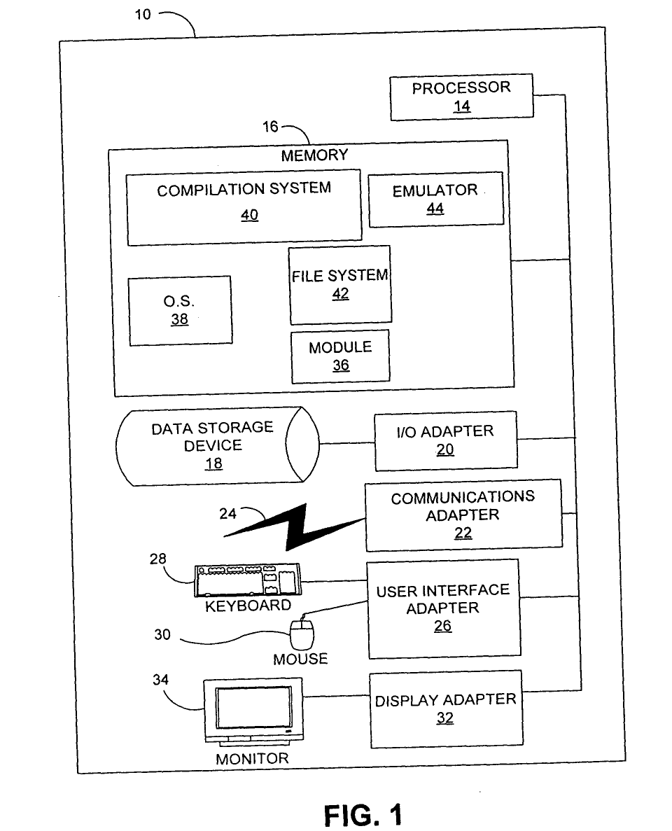

Referring now to FIG. 1 there is broadly illustrated a computer system 10 which may be employed for various embodiments of the present invention. The computer system 10 includes a computer program and various components, such as a processor 14, a computer memory 16, a data storage device 18, an input/output (I/O) adapter 20, a communications adapter 22, a communications network 24, a user interface adapter 26, a keyboard 28, a mouse 30, a display adapter 32, and a computer monitor 34. It is to be understood and appreciated by those skilled in the relevant art that there are many possible configurations and arrangements of the components of the computer system 10 and that some components which may be typically included in the computer system 10 are not shown. Thus, the computer system 10 illustrated in FIG. 1 is for exemplarily purposes only and is not to unduly limit the spirit and scope of embodiments of the present invention.

Computer memory 16 may be any suitable memory storage device, including random access memory (RAM), cache memory, magnetic medium such as a resident hard disk, or other memory storage devices. The term “storage” may refer to computer resources, such as the computer memory 16, and may be employed to store suitable data or instructions. For exemplarily purposes only and as best illustrated in FIG. 1, computer memory 16 may include at least one module 36, an operating system (O.S.) 38, a compilation system 40, a file system 42, and an emulator 44.

The compilation system 40 for various embodiments of the invention would comprise a compiler having a special program that processes statements written in a particular programming language and turns them into machine language or “code” that a processor, such as processor 14, uses. Traditionally, the output of a compilation system, such as compilation system 40, has been called object code or sometimes an object module. It is well known that the object code is machine code that the processor of the computer can process or “execute” one instruction at a time. Thus, stated alternatively, the compiler translates source code into object code, particularly by looking at the entire piece of source code and collecting and reorganizing the instructions.

Continuing to refer to FIG. 1 the processor 14 typically operates in cooperation with suitable software programs, including the computer memory 16, more particularly including the compilation system 40, the O.S. 38 and the module 36. Henceforth, the fact of such cooperation among the processor 14 and these components of the computer memory 16, whether implemented in software, hardware, firmware, or any combination thereof, may therefore not be repeated or further described, but will be implied for purposes of various embodiments of the present invention. It is well known that a module, such as the module 36, typically operates in cooperation with the emulator 44 and the compilation system 40, but is not limited to such operation. By way of example only, the module 36 may operate in cooperation with the O.S. 38, which may in itself cooperate with the compilation system 40. The O.S. 38 may also cooperate with the file system 42 that manages the storage and access to files within the computer system 10.

The module 36 may be implemented in any suitable program language, or in any combination of software, hardware, or firmware. Thus, the module 36 may include instructions and data and be embodied in a computer-readable medium for use by or in connection with an instruction execution system, apparatus, or device, such as the computer system 10 which may pursue and derive any suitable instructions for operation. Any function ascribed to the module 36 and any of its associated functional files, whether implemented in software, hardware, firmware, or any combination thereof, may be included in the functions of the O.S. 38, since the O.S. 38 may include files from the module 36. In some instances, the functions ascribed to the module 36 may be typically performed by the processor 14 executing suitable software instructions in cooperation with aspects of the O.S. 38 that may incorporate the module 36. Therefore, it is to be understood that the module 36 may cooperate with aspects of the O.S. 38.

It will be appreciated by those skilled in the relevant art that the term “execute” may mean the process of manipulating code, such as software, for operation on the computer system 10. It will be further appreciated by those skilled in the relevant art that the term “code” may refer to any suitable instructions or data used by the computer system 10 for the purpose of generating instructions that can execute in the computer system 10. As indicated, the term “module” may refer to a software “procedure” or “function” such as a unit of code that may be independently compiled.

The emulator 44, as well as the compilation system 40 and the O.S. 38, may reside in the computer system 10, more particularly in the computer memory 16 of the computer system 10. The emulator 44 may substitute instructions typically associated with a different computer system than the executing computer system 10, for any original instruction. Any substitute instruction may be associated with a hardware, software, or firmware representation of a different computer system 10.

The data storage device 18 may be any suitable storage device, including a compact disk drive, a tape drive, a removable hard disk drive, or diskette drive. The data storage device 18 may communicate with the I/O adapter 20, which in turn communicates with other components of the computer system 10, in order to retrieve and store data used by the computer system 10. The data storage device 18 typically includes a computer storage medium having stored therein a computer software program and data.

The computer system 10 for embodiments of the present invention includes suitable input/output devices for accepting input information and promulgating generated information. Input/output devices may include any suitable storage device, such as a compact disk drive, a tape drive, a removable hard disk drive, or a diskette drive. Suitable input devices include, by way of example only, the keyboard 28, the mouse 30, a touch-screen display (not shown), a touch pad (not shown), a microphone including a voice recognition device (not shown), a network card (not shown), or a modem (not shown). The input devices may communicate with the user interface adapter 26 which in turn communicates with components in the computer system 10 for processing input and output commands. Program code may typically be loaded through a suitable input device and may be stored on the data storage device 18. A copy of the program code, or any portion thereof, may alternatively be disposed by the processor 14 in the computer memory 16 for subsequent execution on the computer system 10.

Output devices may include any suitable output devices for presenting generated information to a user, whether a human or a machine, and whether local or remote. Such devices may include, by way of example only, the computer monitor 34, a printer (not shown), an audio speaker with a voice synthesis device (not shown), a network card (not shown), or a modem (not shown). Output devices, such as the monitor 34, may communicate with other components in the computer system 10 through the display adapter 32.

The computer system 10 for various embodiments of the present invention may communicate with communications network 24 via the communications adapter 22, such as a networking card. It is to be appreciated that any suitable input/output device employed by the module 36 may be coupled to the communications network 24 through the communications adapter 22 and therefore may not necessarily be co-located with the computer system 10. Similarly other portions of the computer system 10, such as the data storage device 18 and the monitor 34, may be coupled to the communications network 24 through the communications adapter 22 and may also not be necessarily co-located with the computer system 10.

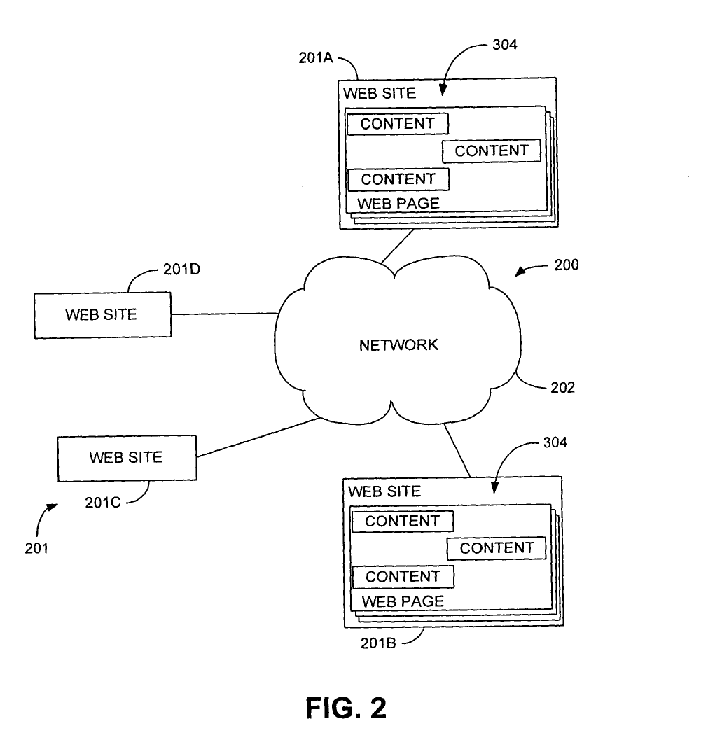

It is to be appreciated that the communications network 24 may be a local area network, a wide area network, or any other suitable computer network, such as network 202 in FIG. 2. Network 202 may be an intranet or the Internet which enables fast and relatively widespread dissemination of information. On the Internet, for example, web sites containing one or more web pages may be accessed by users having a computer system (e.g., computer system 10), a web browser, and a device (e.g., communications adapter 22) for coupling the computer system to the Internet. A web page may contain information on various topics, such as topics (e.g., creating campaigns, redeeming coupons, distribution of coupons, etc) pertaining to electronic-commerce embodiments of the present invention.

Embodiments of the present invention will be described in the context of web page publishing on the Internet. It should be understood, however, that embodiments of the present invention are not to be limited to web page publishing on the Internet and may be used in any suitable electronic-commerce environment, including intranet, telefaxing, telephone, and so forth.

Referring again now to FIG. 2, there is seen a web site assembly, generally illustrated as 200, where embodiments of the present invention may be employed. In FIG. 2 one or more web sites 201 (e.g., web sites 201A, 201B, 201C and 201D) which couple to and communicate with the network 202. As indicated the network 202 may include the Internet, an intranet or any other type of computer networks.

The web site 201 may be hosted in a computer system, such as computer system 10, or any data processing device which is capable of communication over a network, such as network 202. By way of example only, the web site may be hosted in a web server computer such as those available from the Hewlett-Packard Company. As illustrated in FIG. 2, the web site 201 may include one or more web pages, with each page including various contents, such as images, text, computer programs, downloadable files, audio, video, etc. The web pages may be structured such that they are on various levels. For example, a home page may be presented as a first level web page, with a hyperlink on the home page allowing access to a second level web page, and so on.

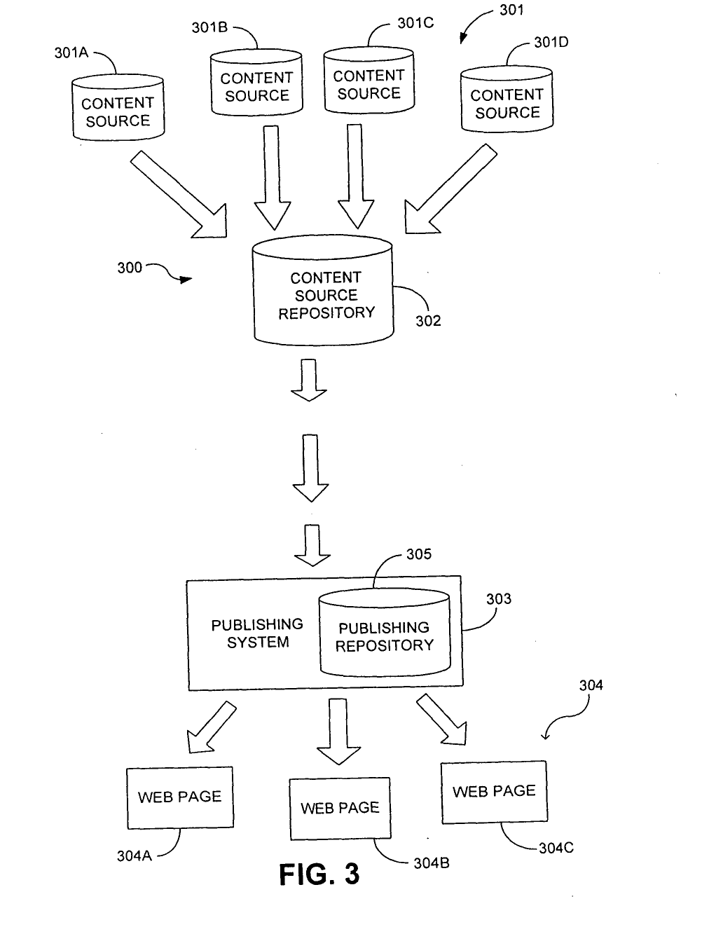

Referring now to FIG. 3, there is illustrated a schematic diagram for a system, generally illustrated as 300, that be used for creating and publishing web pages which may be employed for various embodiments of the present invention. The components of system 300, as well as all other components referred to herein, may be implemented in hardware, software, or a combination of hardware and software, such as firmware. As seen in FIG. 3, a content-source repository 302 receives contents from content sources (e.g., content sources 301A, 310B, 301C and 301D). A content source 301 may a local or remote file system, a remote repository, or web site personnel entering content from a suitable terminal, etc. By way of example only, the content source 301 may be a database in a remote data center in communication with a suitable computer system, such as computer system 10, having the content-source repository 302 (e.g., the data storage device 18 functioning as a repository). The content sources may come from various sources, such advertising and sales from a marketing department. For various embodiments of the present invention content sources may include a field for receiving a campaign name, a field for receiving a distribution type, a field for receiving a product ID, etc.

The content source repository 302 includes a database that serves as a central repository of contents from the various sources. The database may be any suitable data base such as the type available from the Oracle Corporation. Contents may be stored and retrieved from content source repository 302 as data or objects. Contents uploaded to content source repository 302 from a file system may be stored as binary data or referenced with pointers to the file system.

As appreciated by those artisans skilled in the art, content source repository 302 facilitates collection and retrieval of contents. Contents that may be shared among web pages may be stored in the content source repository 302. By storing appropriate contents in the content source instead of simply entering them directly into a web page, contents from different sources may be created once and used multiple times in different web pages. Content source repository 302 also facilitates control of content type and format so that the resulting web pages conform to a common standard, maintain a consistent look and feel, and uniformly display brands or trademarks and the like.

Appropriate content may be removed or pulled from content source repository 302 as needed by a computerhosting publishing system 303 which publishes a web page 304 (e.g., web pages 304A, 304B, 304C) in a suitable computer network, such as an intranet or Internet. Publishing system 303 includes a publishing repository 305 (e.g., a database) for storing contents of web pages to be published. As indicated, such contents may be copied from content source repository 302 into a publishing repository 305. This allows web pages 304 to receive content from publishing repository 305.

Storing the content of web pages 304 in publishing repository 305 removes a storage burden from the content source repository 302 and facilitates publication of web pages 304. Additionally, it allows available contents in the provisioning repository 302 to be separated from contents (i.e., those in publication repository 305) which are to be published for better control of the publication process by the publishing system 303 and web pages 304.

A web page 304 may be published by storing it in a web server computer. A web page 304 may also be published by dynamically creating and delivering it to a node in a computer network upon request. Once a web page 304 is published, computers coupled to the same network as the web server computer may then access the web page 304. For example, the web page 304 may be published by making it available from a web site accessible via the intranet or the Internet.

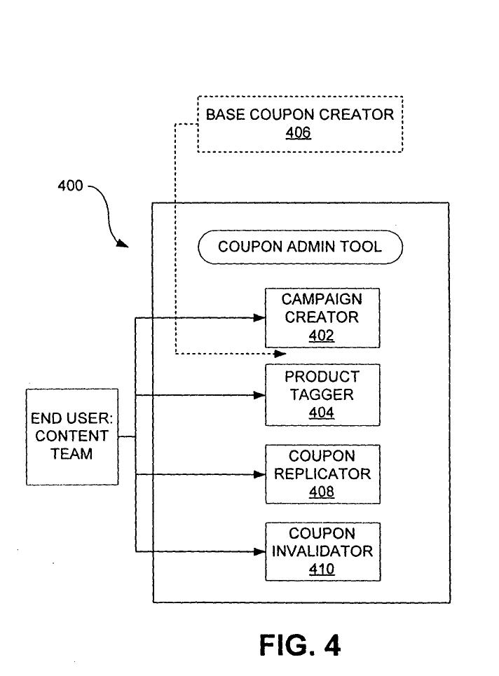

Referring now to FIG. 4 there is seen a coupon administrator tool, generally illustrated as 400. The information for producing and opening or exposing the coupon administrator tool 400 would be stored in data storage device 18 and/or memory 16 of the computer system 10. The coupon administrator tool 400 may be used by any person or entity (e.g., any commercial supplier such as Hewlett Packard, etc) for creating a campaign, tagging a product, creating a base coupon, and replicating and invalidating a coupon. The coupon administrator tool 400 would typically be available through a suitable display, such as on the monitor 34 of the computer system 10 of FIG. 1, and may include the following buttons, icons, or similar symbols: campaign creator 402, product tagger 404, base coupon creator 406, coupon replicator 408, and coupon invalidator 410. The coupon administrator tool 400 enables a user (e.g., commercial supplier) to perform the following functionalities: (i) creating a campaign which is an identification that ties a promotion to a discount on future products described in an offer, such as an offer published on the web page 304; (ii) tagging products related to a particular campaign; (iii) replicating a coupon from a base coupon (an exemplary coupon for non-distribution purposes) for a campaign; and (iv) invalidating a coupon for a campaign.

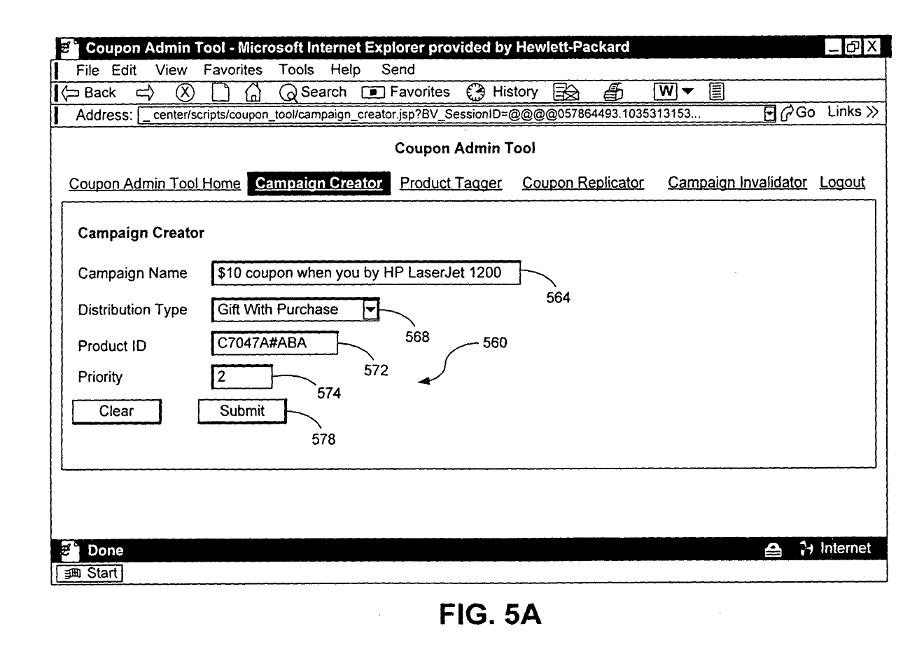

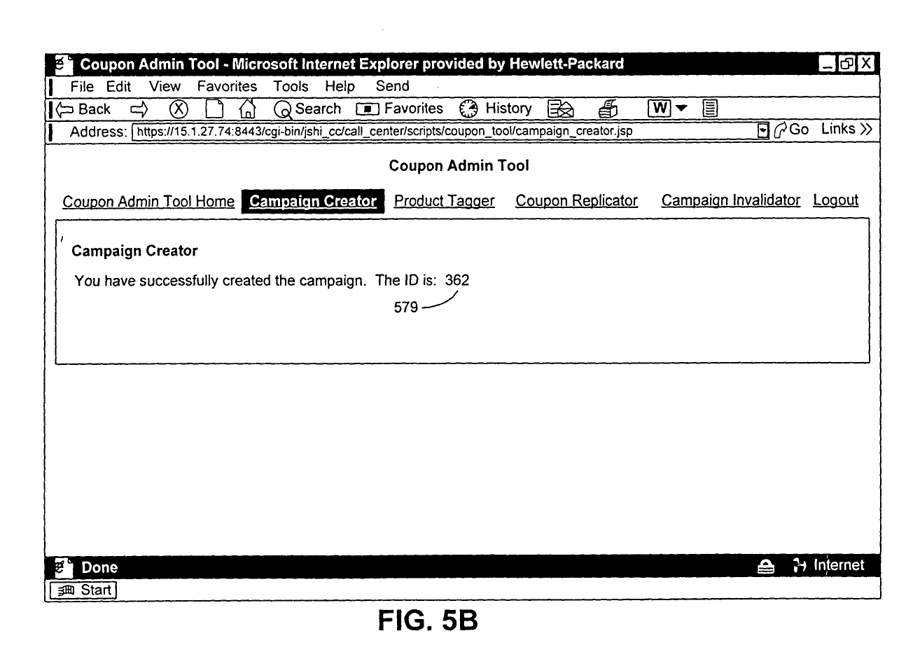

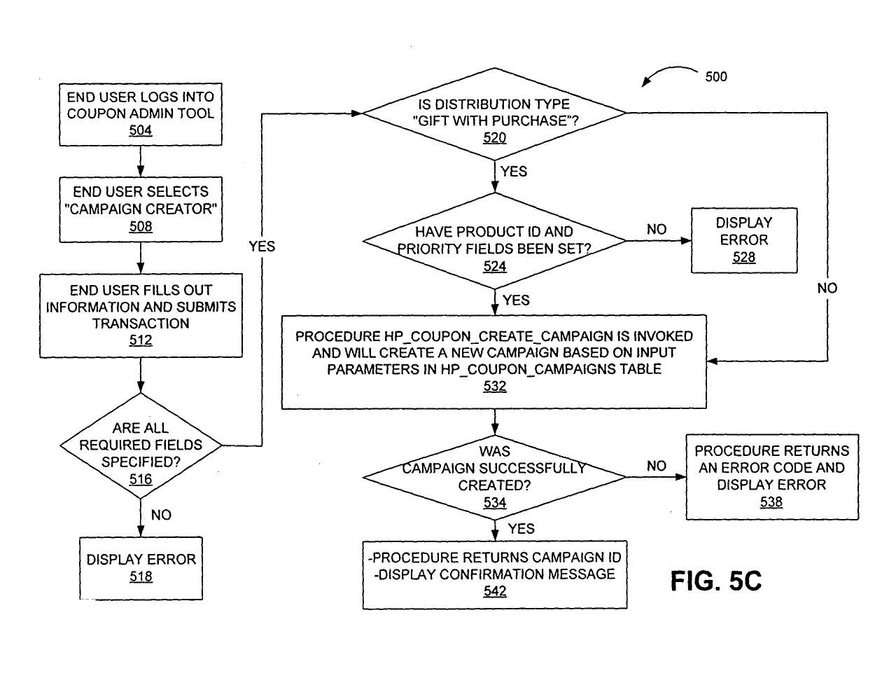

The user (e.g., corporate content administrator) or campaign creator may create a campaign by clicking on or otherwise opening the icon/block designated as campaign creator 402. When campaign creator 402 has been opened, appropriate fields 560 are exposed as illustrated in FIG. 5A for the campaign creator to subsequently specify therein the following: campaign name, distribution type, product identification, and priority. More specifically, and continuing to refer to FIG. 5A, fields 560 includes campaign field 564, distribution field 568, product field 572, and priority field 574.

The campaign field 564 receives a campaign name from the campaign creator. This field typically includes an input text field and may receive any suitable number of characters, such as 100 or less. The campaign name may be any suitable name, such as “$10 coupon when you buy HP Laser Jet 1200” as illustrated in FIG. 5A.

The distribution field 568 receives a distribution type selected from the following types of coupon distributions: third (3^{rd}) party type of distribution, customer satisfaction type of distribution, and gift with purchase type of distribution. A third party type of coupon distribution is a distribution where the third party receives a coupon after a product is bought by a party (e.g., a commercial buyer or customer). A customer satisfaction type of coupon distribution is a distribution where a dissatisfied or not totally satisfied commercial buyer or customer is given a coupon. A gift with purchase type of coupon distribution is a distribution where a party is given a coupon after a product is bought by the party. As indicated, any issued coupon would be a credit or discount on one or more products described in an offer. The credit or discount would typically be a future credit or discount towards a future purchase of one of more products.

The product field 572 receives an appropriate product identification to indicate which product is tied to a particular type of distribution campaign (e.g., a gift with purchase campaign). The product identification may be any suitable identification, such as an alphanumeric identification. In FIG. 5A the product identification in product field 572 is illustrated as “C7047A#ABA”.

The priority field 574 receives a numeral (e.g., “2” as illustrated in FIG. 5A) that is indicative of the order in which to insert or distribute a coupon in case there is more than one campaign of a particular distribution type (e.g., gift with purchase distribution type) for an order. Stated alternatively, the priority number indicates the order in which the computer would check and/or examine each product in a single purchase order having a plurality of products to determine if a coupon is available for any one product in the single purchase order. The number in the priority field 574 will typically range from 1 to 25. A party (e.g., a customer) purchasing a product may receive a generic coupon which is good for any future product, or a specific coupon which is tied to a particular product. In an embodiment of the invention, a coupon is typically valid for only one order, and is or may be tied to a party (i.e, the user of the coupon) so there is a guarantee of only a single use. An untied coupon is a coupon which is not tied to any particular party; thus, it is available for use by any coupon possessor purchasing any product.

By way of illustration only with respect to illustrating how a priority number functions for distributing a coupon, assume that a party is purchasing under a single order the following products: Laser Jet; Ink Jet; Scanner; and CD Writer. The priorities have been fixed by the commercial supplier and, as indicated, only one coupon is to be distributed for all of the foregoing products under the single order, provided that a coupon is available for any one product in the single purchase order. After a customer submits an order, such as through the web site assembly 200, the computer then determines the priorities of two or more products in the single purchase order. It is assumed that the subject products have the following priorities: priority 1 for the CD writer; priority 2 for the Ink Jet; priority 3 for the Laser Jet and priority 4 for the Scanner. After the customer submits the single purchase order with these products, the computer initially determines if any coupons are available for the CD writer, and/or if there was a limit on the number of coupons issued for the CD writer. The administrator for the coupon administrator tool 400 may or may not limit the number of coupons for any particular product. Alternative to, or in conjunction with determining if any coupons are available for the CD writer, the computer determines if the campaign for the CD writer has expired (i.e., a time period for purchasing the CD writer and receiving a coupon has ended). If a coupon is available for the CD writer, and/or the campaign has not expired, the customer/purchaser will receive a coupon for the single purchase order.

As indicated, the issued coupon may be tied to the CD writer, or the issued coupon may be valid for any future product. If all available coupons have already been distributed for the CD writer (e.g., only 10,000 coupons were issued for the CD writer, all of which have been exercised by other customers), and/or the campaign has expired for the CD writer (e.g., the time period for the campaign towards the CD writer), the computer then proceeds to the priority 2 product, the Ink Jet, and determines if any coupons are available for the priority 2 product, and/or if the campaign for the Ink Jet is still active and not expired. If all available coupons have not been distributed and the campaign for the Ink Jet has not expired, a coupon will be distributed to the purchaser or customer towards the priority 2 product Ink Jet. If coupons are not available for the Ink Jet and/or if the campaign for the Ink Jet has expired, the procedure continues for the priority 3 product, the Laser Jet printer. Thus, the number in the priority field (e.g., priority field 574) controls the rankings of a particular product when the particular product is being purchased along with additional products in a “gift with purchase” type of distribution. The priority field will indicate and controls which coupon to insert or distribute in an “order confirmation email” in case there is more than one campaign and coupon of distribution type “gift with purchase” for a single order.

After the end user or commercial supplier has inserted respectively the campaign name, distribution type, product identification, and priority number in campaign field 564, distribution field 568, product field 572, and priority field 574, the end user clicks on submit 578 to successfully create a campaign and to receive a campaign ID 579. As best shown in FIG. 5B, the campaign in FIG. 5A was successfully created and received a campaign ID 579 of “362” (see “You have successfully created the campaign. The ID is: 362” in FIG. 5B).

Referring now to FIG. 5C there is seen a logic flow diagram 500 employed by a computer (e.g., computer system 10 including appropriate code) for creating a campaign. In block 504 the end user logs in the coupon administrator tool 400 which may be set forth or otherwise presented on one or more of the web pages 304 of the publishing system 303. When the coupon administrator tool 400 is suitably displayed, such as illustrated in FIG. 4, the user selects campaign creator 402, as represented by block 508, to commence the process of creating a campaign. The user clicks on or otherwise opens the file for creating a campaign by clicking on campaign creator 402. Subsequently as illustrated by block 512 the end user fills in the appropriate information in the required field. As indicated, the appropriate information to be submitted by the end user comprises the campaign name, the distribution type (i.e., gift with purchase, customer satisfaction, or third party), the product identification, and the priority. After all fields have been filled out by the end user, the end user submits the transaction, such as by clicking on submit 578 in FIG. 5A, and then the computer (e.g., computer system 10 including appropriate code) determines the following: are all required fields specified as represented by block decision block 516, is the distribution type “gift with purchase” as represented by decision block 520, and have product ID and priority fields be set as represented by decision block 524.

If all required fields have not been specified or contain information, a display error will be displayed to the end user in accordance with block 518. If the type of distribution is not a “gift with purchase” type of distribution, then, as represented by block 532, a campaign (i.e., a “third party” or “customer satisfaction” type of distribution) will be created based on input parameter(s) listed in a table (identified as “Table I” below). If the type of distribution is a “gift with purchase” type of distribution, then the computer will determine if the end user has correctly set or designated the product ID and priority fields, as indicated by block 524. If the product ID and priority fields have not been appropriately set, the computer returns an error code and displays an error, as illustrated by block 528. If the product ID and priority fields have been appropriately set, the procedure represented by block 532 is conducted; that is as seen in block 532 of FIG. 5C, “Procedure HP_COUPON_CREATE_CAMPAIGN is invoked and will create a new campaign based on input parameters in HP_COUPON_CAMPAIGNS table”. In order to create a campaign the input parameters in the following Table I are employed:

TABLE I
HP_COUPON_CAMPAIGNS

| COLUMN | DATATYPE | CONSTRAINTS | DESCRIPTION |
|---|---|---|---|
| Id | Number(3) | Primary key | Campaign id |
| | | Create sequence | |
| Description | Varchar2(100) | | Description |
| Distribution | Number(2) | Foreign key to hp | Possible values: |
| Type | | coupon distribution | 3^{rd} party |
| | | types−>type | Customer satisfac- |
| | | | tion |
| | | | Gift with purchase |
| Product ID | Varchar2(80) | | Product ID that is |
| | | | tied to “Gift with |
| | | | purchase” campaign |
| Priority | Number(2) | Default 0 | If there is more than |
| | | | one “Gift with pur- |
| | | | chase” campaign |
| | | | applicable to order, |
| | | | this field will be |
| | | | used to select which |
| | | | coupon campaign |
| | | | will be attached to |
| | | | order |
| Status | Number(2) | Default 1 | Indicate whether |
| | | | campaign is active |

TABLE II
HP_COUPON_DISTRIBUTION_TYPES

| COLUMN | DATATYPE | CONSTRAINTS | DESCRIPTION |
|---|---|---|---|
| Type | Number(2) | Primary key | Distribution type |
| Description | Varchar2(100) | | Description |

Under “Column” in the foregoing Table I, the following parameters are listed: Id (i.e., campaign identification), description (i.e., description of the campaign), distribution type (i.e., third party, customer satisfaction, or gift with purchase), product ID (i.e., identification of the product), priority (i.e., a number which selects which coupon campaign will be attached to order if there is more than one “gift with purchase” campaign applicable to order), and status (i.e., indicates if campaign is active or not). Under “Column” in the foregoing Table II, the parameters “type” (i.e., distribution type) and “description” (i.e., description of the coupon) are listed.

Under “datatype” in both Table I and Table II, either a number or “varchar” (various or alphanumeric characters) is listed. “Number(3)” corresponding to “Id” in Table I connotes a three digit number, such as “362” is FIG. 5B. “Varchar2(100)” corresponding to “description” in both Table I and Table II is a string having a limit of one hundred characters. “Number(2)” respectively corresponding to “distribution type” and “type” in Table I and Table II connotes a two digit number. “Varchar2(80) corresponding to “product ID” in Table I is a string having a limit of eighty characters. “Number(2)” corresponding to “priority” in Table I connotes a two digit number. “Number(2)” corresponding to “status” in Table I also connotes a two and indicates whether a campaign is active.

Under “constraints” the limitations and/or constraints of the parameters listed under “column” are provided. “Primary key Create sequence” corresponding to “Id” in Table I means a unique ID value. A sequence will be used when a call center agent creates a campaign (or issues a coupon) and the sequence number bill be the campaign ID (or transaction ID for coupon issuing). “Primary key” corresponding to “type” in Table II means a unique type. “Foreign key to hp_coupon_distribution_types→type” corresponding to “distribution type” in Table I means its value in Table I must match one of the values for coupon distribution types in Table II (i.e., coupon distribution types under HP_COUPON_DISTRIBUTION_TYPES in Table II). Also, and as indicated, under certain embodiments of the present invention, there will only be one campaign with distribution type “gift with purchase”. “Default 0” corresponding to “priority” means its value by default is “0”. “Default 1” corresponding to “status” means it value by default is “1”.

Continuing to refer to FIG. 5C, if the distribution type is not a gift with purchase, then the logic flow of the computer system bypasses the testing and/or determining of decision block 524 if the product ID and priority fields have been set, and proceeds to create a campaign from the remaining parameters in Table I. Thus, by way of example only, if the distribution type is a customer satisfaction type of distribution, the logic flow of the computer system bypasses obtaining and/or testing for product ID and priority fields parameters, and subsequently determines the status (i.e., either active or inactive/expired) of the customer satisfaction type of distribution. If the status is active, then the test or determination of decision block 534 will be positive and a campaign ID and confirmation message will be displayed in accordance with block 542 (e.g., as illustrated in FIG. 5B). If the status is inactive, then the test or determination of decision block 534 will be negative and an error will be displayed in accordance with block 538.

If the distribution type is a gift with purchase in accordance with a positive response by decision block 520, then the logic flow of the computer system proceeds to decision block 524 to test and/or determine if the product ID and priority fields have been set. If the product ID field and/or the priority field have/has not been set, then the computer system will display an error in accordance with block 528. If the product ID and priority fields have been set as would be indicated by a positive response to decision block 524, the logic flow of the computer system proceeds to create a campaign from the remaining parameters in Table I by subsequently determining the status (i.e., either active or inactive/expired) of the gift with purchase type of distribution. If the status is active or not expired, then the determination of decision block 534 will be a positive determination, and a campaign ID and confirmation message will be displayed in accordance with block 542 (e.g., as illustrated in FIG. 5B). If the status is inactive or has expired, then the determination of decision block 534 will be a negative determination and an error will be displayed in accordance with block 538.

Thus, the coupon-create campaign procedure as broadly illustrated in FIGS. 5A, 5B and 5C will create a campaign based on the following input parameters:

Campaign name (p_campaign_name)

Distribution type (p_distribution_type)

Priority (p_priority)

Product ID (p_prod_id) for campaigns other than Gift with Purchase, use “NULL”

The coupon-create campaign procedure will return the output parameter p_campaign_id with the following codes:

Campaign ID if campaign is successfully created (non-zero positive number)

−1 if a system error has occurred

−2 if a “Gift with purchase campaign” already exists for specified product ID

−3 if product entered does not exist in BV_PRODUCT table

−4 if campaign with same name already exists

−5 if gift with purchase campaign is already existing with same priority

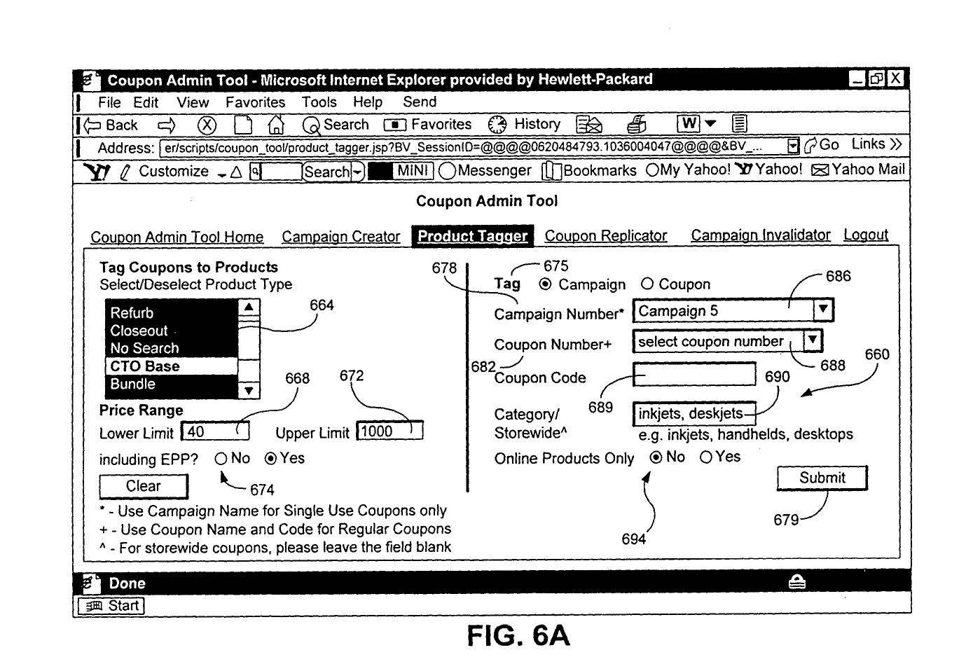

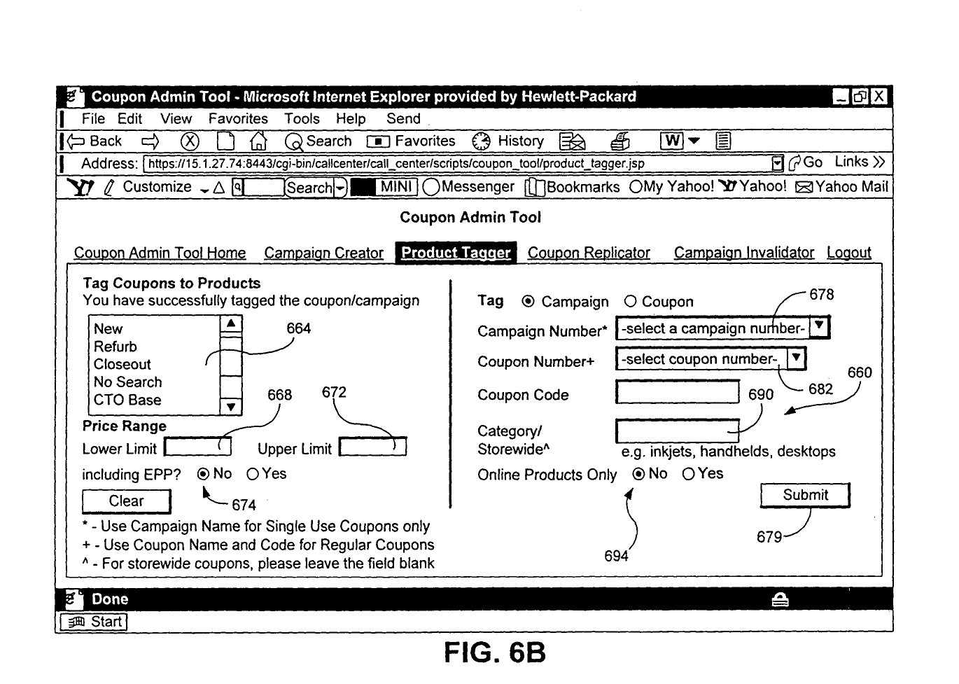

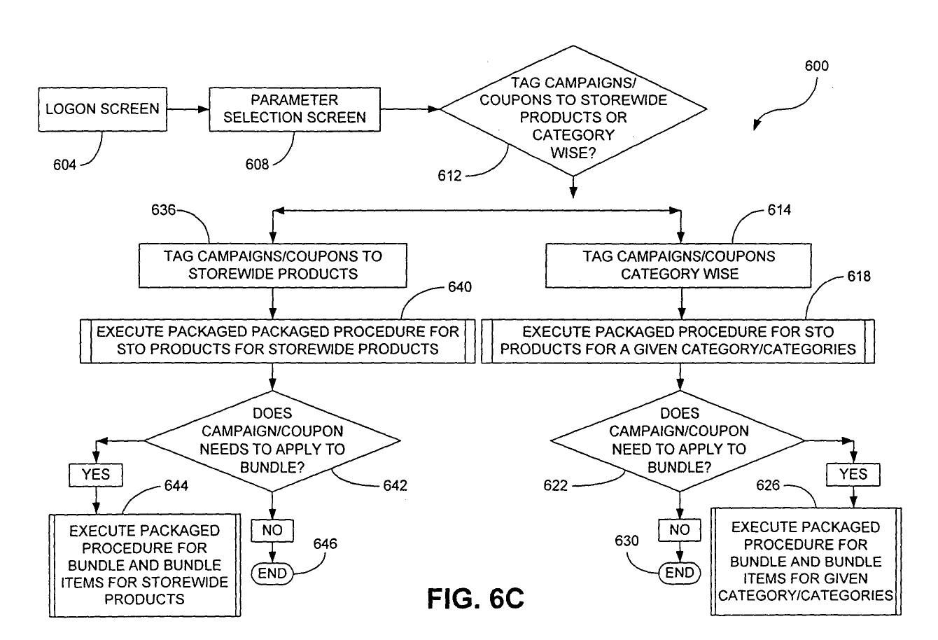

Referring again now to FIG. 4, the user (e.g., corporate content administrator) may tag a product by clicking on or otherwise opening the icon/block designated as product tagger 404. When product tagger 404 has been opened, appropriate fields 660 are exposed as illustrated in FIG. 6A for the user to subsequently specify therein the following to tag products related to a coupon or campaign: product type, lower limit, upper limit, whether or not employee purchase program (EPP) is included, whether to tag a campaign or a coupon, campaign number, coupon number, campaign value, coupon value, coupon code, category/storewide, and online products only. More specifically, and continuing to refer to FIG. 6A, fields 660 includes product type field 664, lower limit field 668, upper limit field 672, EPP field 674, tag field 675, campaign number field 678, coupon number field 682, campaign value field 686, coupon value field 688, coupon code field 689, category/storewide field 690, and online products field 694.

The product type field 664 receives from the user the product type/types for which a coupon needs to be tagged. The product type parameter will display all ship to order (STO) product types and Bundle (i.e., a number of products represented by a single product).

The lower limit field 668 receives from the user a price typically in dollars (e.g., “40” as seen in FIG. 6A). Coupons may be tagged to products above or equal to this price. If a decision has been made to tag all products below a particular price, there would be no need to set a lower limit with a price and this parameter would be left empty by entering no price or “default 0” in the lower limit field 668.

The upper limit field 672 receives from the user a price typically in dollars (e.g., “1000” as seen in FIG. 6A). Coupons may be tagged to products below or equal this price. If a decision has been made to tag all products above a particular price, there would be no need to set an upper limit with a price and this parameter would be left empty by entering no price in the upper limit field 672. If the lower limit price is greater than the upper limit price, an error message would be displayed.

The EPP field 674 receives either “yes” or “no”. If the parameter “yes” is entered in the EPP field 674, EPP products would be tagged. If the EPP products are not to be tagged, “no” (i.e., the default value) would be entered in the EPP field 674. Tag field 675 is for “tag” so either a campaign or a coupon may be tagged.

The campaign number field 678 receives the verbiage “campaign number” and campaign value field 686 may receive any suitable number, such as Campaign1, Campaign2 . . . Campaign25 (e.g., see “Campaign 5” in FIG. 6A). This number represents which coupon from campaign(s) represented by Campaign1, Campaign2 . . . Campaign25 needs to be tagged. This parameter is employed for single use coupons. For regular coupons (i.e., non-singular use coupons) this parameter would not be used and the campaign value field 686 would be left blank or empty. The campaign value field 686 (typically a displayed only field) is assigned “Campaign Value 1” if the campaign number is not zero(0) or null. If the campaign number is not zero(0) or null, then a zero(0) is assigned to the campaign value field 686.

The coupon number field 682 receives the verbiage “coupon number”, and coupon value field 688 may receive any suitable number or value. More specifically, the coupon value field 688 may receive any suitable coupon code value that a customer would enter during the checkout process to redeem a discount for a purchase. For regular use coupons, this parameter (i.e., coupon code value) would be specified. For single use coupons this parameter would not be used and the coupon value field 688 would be left blank or empty. In an embodiment of the invention, a user would enter coupon values only if the coupon number is not null or zero. In another embodiment of the invention, the coupon value to be inserted or assigned to the coupon value field 688 would be a value less than a price to ship the particular product to which the coupon is applicable.

The coupon code field 689 may receive any suitable code or number such as Coupon1, Coupon2 . . . Coupon25. This number represents which coupon from coupon(s) represented by Coupon1, Coupon2 . . . Coupon25 needs to be tagged. Coupon name and coupon code are used for regular coupons.

The category/storewide field 690 receives product category/categories which are to be tagged. If a coupon needs to be tagged to all storewide products, then leave this parameter empty, such as by entering zero(0) in the category/storewide field 690 or leaving the same blank. If coupon(s) needs to be tagged to products belonging to specific category/categories, then the specific category/categories is/are entered, separated by commas if more than one category. For example, if only products belonging to desktops, notebooks and handheld need to be tagged, then the user would enter “desktops, notebooks, handheld”.

The online products field 694 receives either “yes” or “no”. If the parameter “yes” is entered in the online products field 694, a coupon needs to be tagged to only online products. If coupon(s) need to be tied to both online and offline products, “no” (i.e., the default value) would be entered in the online products field 694. Thus, a default entry (a “0”) or assigning “no” to the online products field 694 means tag coupon(s) to online and offline products.

After the user/commercial supplier has inserted into respective fields (i.e., product type field 664, lower limit field 668 . . . online products field 694) the appropriate information (i.e., product type, the lower limit . . . online products only), the end user clicks on submit 679 to successfully tag one or more products. As best shown in FIG. 6B, the product(s) in FIG. 6A was successfully tagged (see “You have successfully tagged the coupon/campaign tagged” in FIG. 6B).

Referring now to FIG. 6C there is seen a logic flow diagram 600 employed by a computer system (e.g., computer system 10) for tagging one or more products. In block 604 the end user logs on to commence the process of tagging one or more products. The user clicks on or otherwise opens the file for tagging one or more products by clicking on product tagger 404. Subsequently, as illustrated by block 608, a parameter selection screen is displayed (e.g., the screen or monitor illustrated in FIG. 6A), and the end user fills in the appropriate information in the required field. As indicated, the appropriate information to be submitted by the end user may comprise: product type, lower limit, upper limit, EPP, campaign number, coupon number, campaign value, coupon value, coupon code category/storewide, and online products only. After appropriate information has been assigned to all fields by the end user, the end user submits the transaction, such as by clicking on submit 679 in FIG. 6A, and then the logic flow is continued by the computer system (e.g., computer system 10 including appropriate code) for tagging a campaign or coupon to storewide or category wise products. Decision block 612 represents determining if campaigns/coupons are to be tagged to storewide products or to products for a given category/categories.

If products for a given category/categories are to be tagged, then such products are tagged in accordance with block 614. Subsequently, as illustrated by block 618, packaged procedure for STO products is executed for a given category/categories, and then a determination is made in accordance with decision block 622 if the campaign/coupon needs to apply to a bundle. If it is determined that the campaign/coupon applies to a bundle, packaged procedure for bundle is executed as illustrated by block 626 and items/products for given category/categories are bundled. If it is determined that the campaign/coupon does not apply to bundle, then the logic flow terminates with end block 630.

If storewide products are to be tagged, then such products are tagged in accordance with block 636. Subsequently, as illustrated by block 640, packaged procedure for STO products is executed for storewide products, and then a determination is made in accordance with decision block 642 if the campaign/coupon needs to apply to a bundle. If it is determined that the campaign/coupon applies to a bundle, packaged procedure for bundle is executed as illustrated by block 644 and storewide items/products are bundled. If it is determined that the campaign/coupon does not apply to bundle, then the logic flow terminates with end block 646.

Thus, the campaign/coupon-tag product procedure will tag campaigns/coupons to products based on the following input parameters:

Product Type (p_product_type)—this parameter will display all STO product type(s) and Bundle(s). User should select product type/types for which coupon needs to be tagged.

Lower limit (p_lower_limit)—Tag coupon to products having a price above or equal to this price. If the respective price(s) of all products below some price need to be tagged, there would be no need to set a lower limit. In such case(s), this parameter is left empty (e.g., Default 0).

Upper limit (p_upper_limit)—Tag coupon to products having a price below or equal this price. If the respective price(s) of all products are above some price, there is no need to check or enter upper limit. In such case, this parameter is left empty. If lower limit>upper limit, an error message is displayed.

EPP (p_epp_also)—Tag EPP products if parameter is “Yes”. Default value is “No”

Campaign Number (p_campaign_number)—The database stores Campaign1 . . . Campaign25. This number represents which coupon from Campaign1 . . . Campaign25 needs to be tagged. For single use coupons this parameter is used, for regular coupons default value to 0.

Coupon Number (p_coupon_number)—The database stores Coupon1 . . . Coupon25. This number represents which coupon from Coupon1 . . . Coupon25 needs to be tagged. For regular coupons this parameter is used, for single use coupons, default value to 0.

Campaign Value (p_campaign_value)—This field is a displayed only field. If campaign number is not null, then assign campaign value 1, else default to 0.

Coupon Value (p_coupon_value)—Enter coupon value. For regular coupons this parameter is used, and for single use coupons this parameter is left empty. User may enter coupon values if coupon number is not null. Default to “NULL” if this field is not used.

Category/Storewide p_category_storewide).—If coupon needs to be tagged to all storewide products then this parameter is left empty. If coupon needs to be tagged to products belongs to specific category/categories, then enter category/categories separated by commas. For example: if only products belonging to Desktops, Notebooks and Handheld need to be tagged, then user will enter Desktops, Notebooks, Handheld. Default to “NULL” if this field is not used.

Online Products Only (p_online_only)—Select “yes” if coupon needs to be tagged to only online products. Select “No” if coupon needs to be tagged to both Online and Offline products. Default is “No” (e.g., default “0” means tag coupon to Online and Offline products).

The output p_result parameter will return the following values:

0 if procedure successfully tagged the products

−1 if a system error occurred

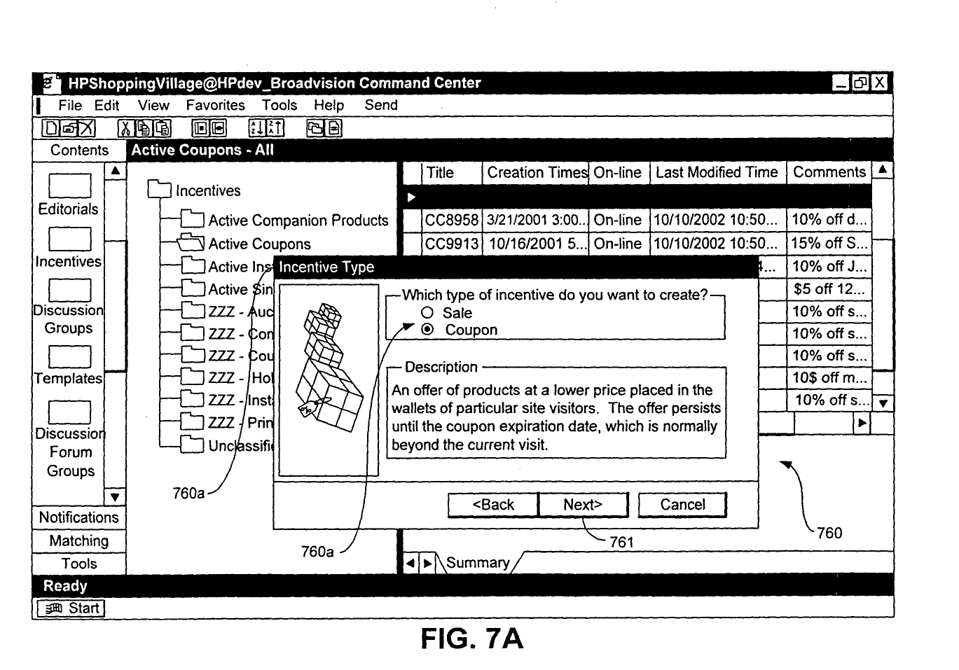

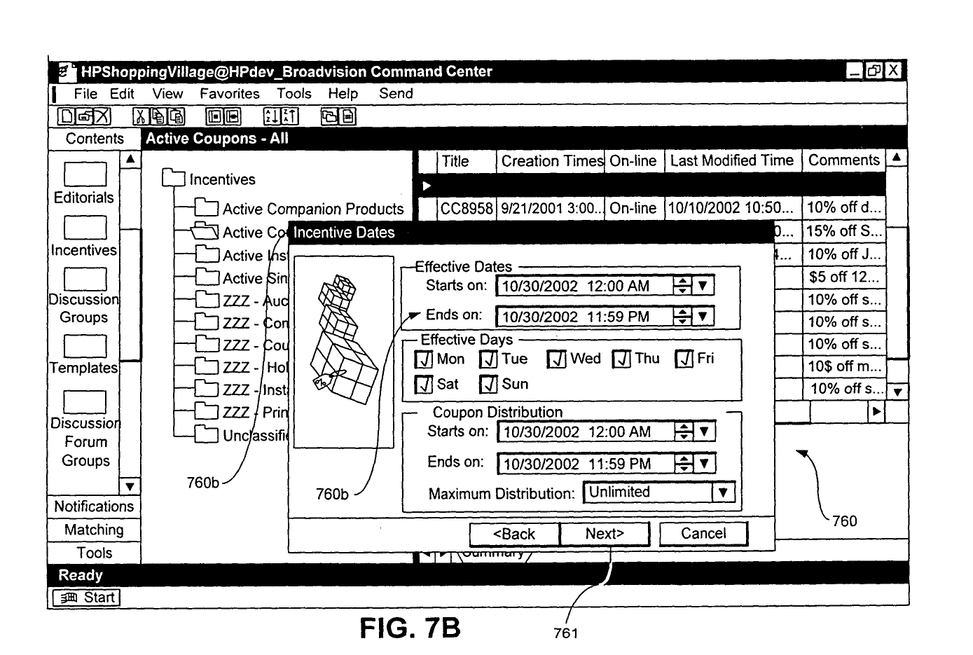

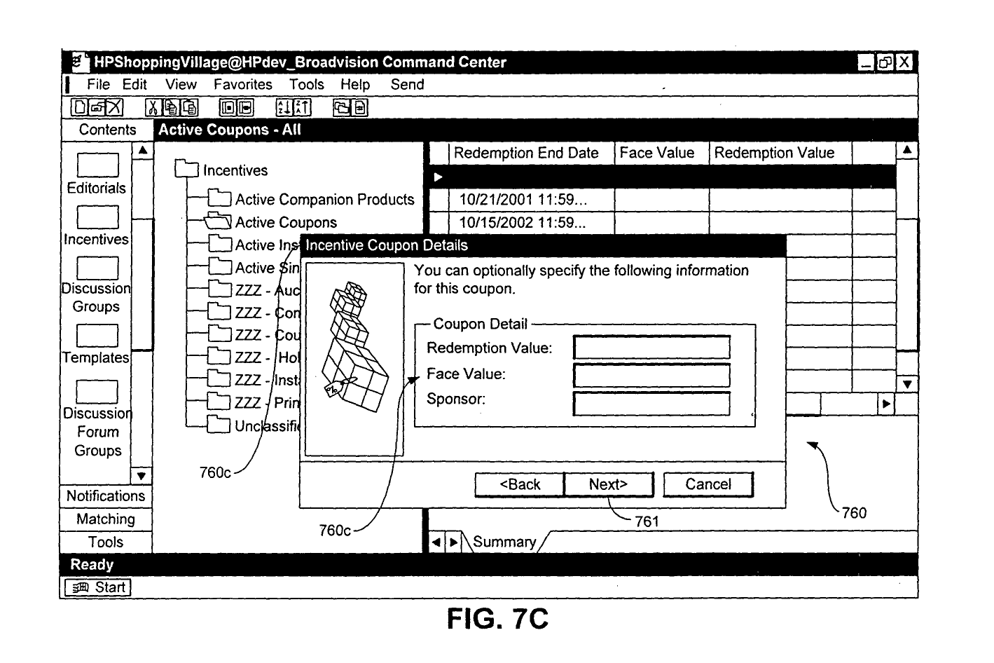

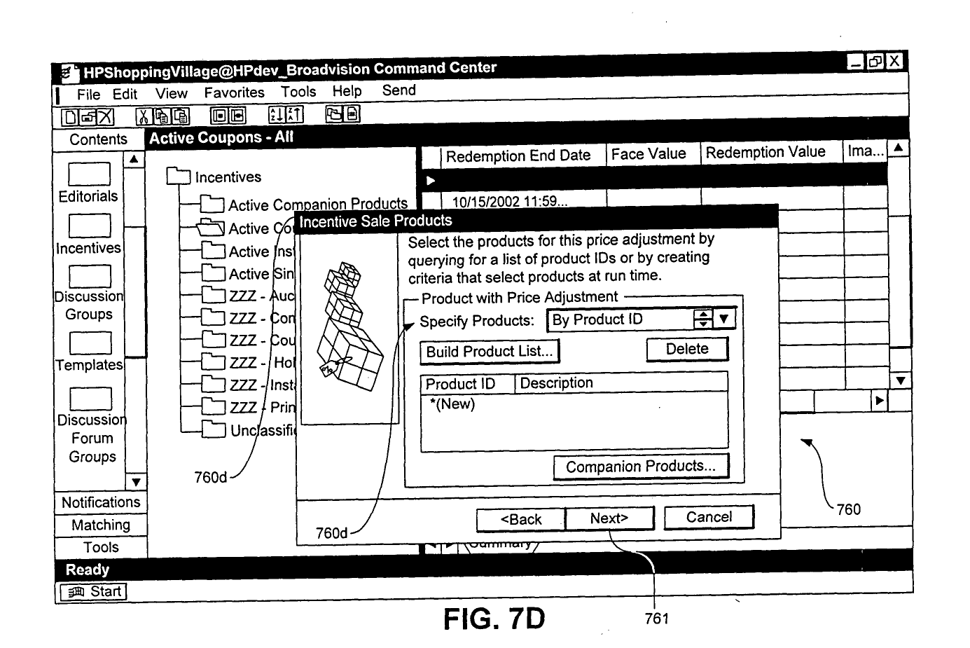

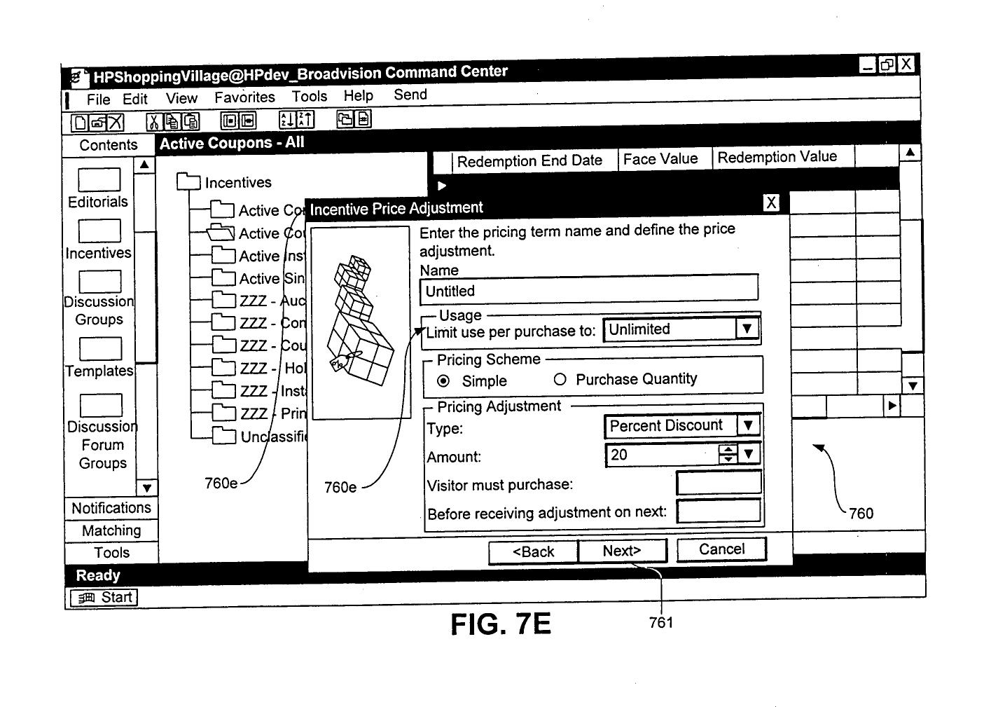

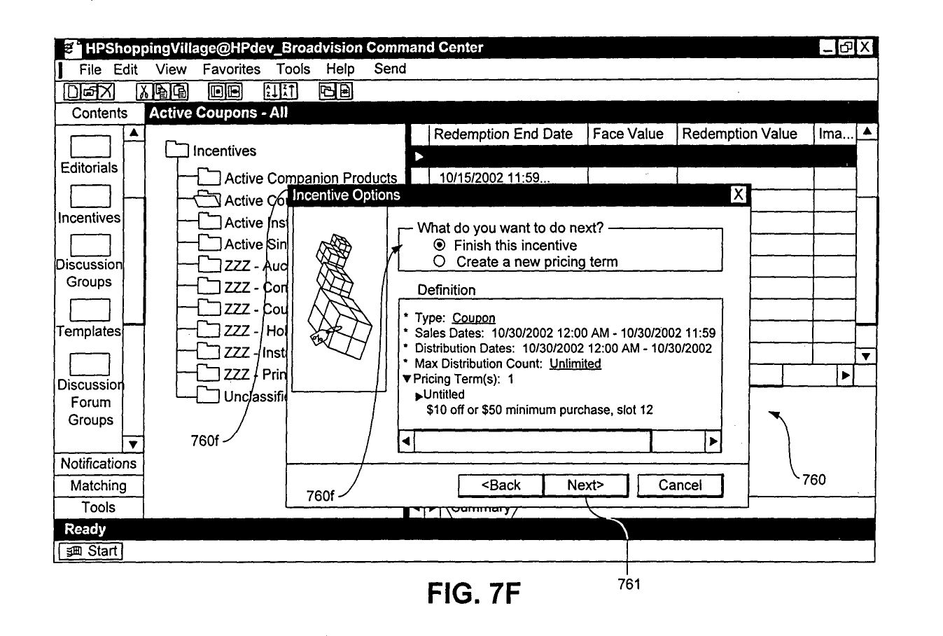

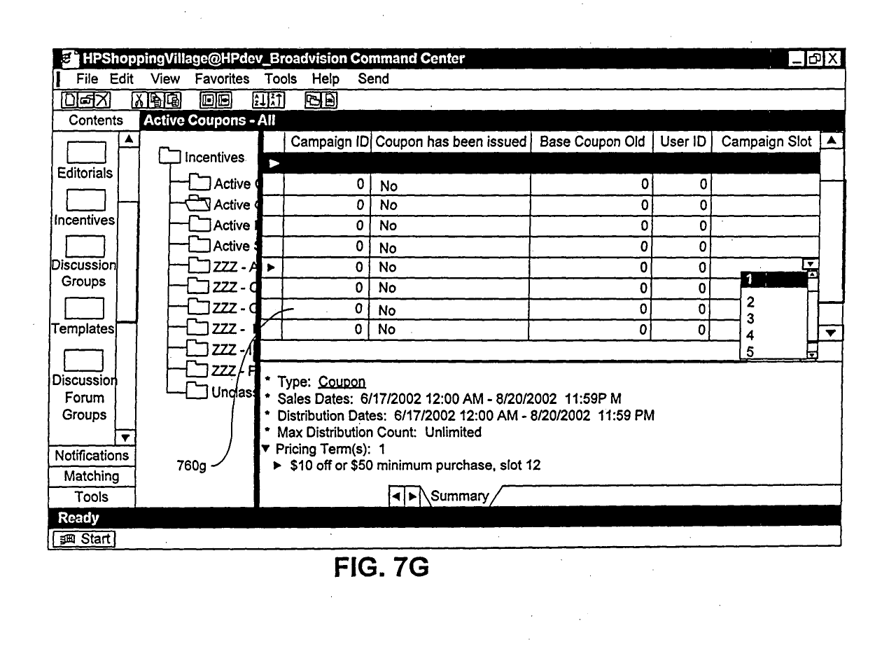

Referring again now to FIG. 4, the user (e.g., corporate content administrator) may create a base coupon by clicking on or otherwise opening the icon/block designated as base coupon creator 406. When base coupon creator 406 has been opened, incentive fields 760 are exposed as illustrated in FIGS. 7A-7G for the user to subsequently specify therein appropriate information for creating a base coupon from which one or more replications will be made.

Referring more specifically now to FIG. 7A, there is seen a screen or monitor displaying an incentive type fields 760a where an end user selects which type of incentive (e.g., incentives comprising active companion products, active coupons . . ., ZZZ pricing supplies promos-old, unclassified) the end user wishes to create. The end user may select a “sale” or a “coupon” type of incentive after selecting “active coupons” incentives, as illustrated in FIG. 7A. The selected “sale” or “coupon” may have any suitable description. The description of the selected coupon in FIG. 7A is: “An offer of products at a lower price placed in the wallets of particular site visitors. The offer persists until the coupon expiration date which is normally beyond the current visit.” After the type of incentive (e.g., sale or coupon) has been entered, the end user clicks on next 761 to bring up the next screen display.

Referring now to FIG. 7B there is seen the next screen display after the screen display of FIG. 7A. More specifically, there is seen a screen display having incentive dates field 760b where effective dates and coupon distribution dates/times are entered. Effective dates may include date and time of starting and ending a coupon distribution (or campaign). Effective dates for the coupon distribution could be any day from Monday through Sunday. The entry under “coupon distribution” would be start and ending dates along with the designation of the maximum number of coupons for distribution (e.g., 10,000, unlimited number, etc.). After fields of the incentive dates field 760b have received an entry, the end user clicks on next 761 to expose the next in line screen display, which is represented by the screen illustrated in FIG. 7C.

In FIG. 7C there is seen incentive field 760 comprising incentive-coupon details field 760c for optionally specifying the following information for any desired coupon: redemption value of the coupon, face value of the coupon, and sponsor of the coupon. After inputting these entries, or electing to leave these entries blank, the end user clicks next 761 to expose a subsequent screen, which is broadly illustrated by the screen of FIG. 7D.

Referring now more specifically to the screen illustrated in FIG. 7D, there is seen incentive field 760 including an incentive select-product field 760d for receiving the designation of product(s) whose price is/are to be adjusted. The products may be selected or designated by ID or by criteria. FIG. 7D illustrates specifying “By Product ID”. After product(s) for price adjustments has/have been specified, the list may be expanded by clicking “Build Product List”. As further illustrated in FIG. 7D, a description of the product represented by the Product ID may be entered, and companion products of the product may be found by the computer system by clicking “companion products”. Subsequently, a screen displaying the kind of product adjustment may be displayed on the monitor by clicking next 761.

The incentive field 760 in FIG. 7E includes incentive price-adjustment field 760e where the price adjustment may be defined. More particularly, the following entries may be made in the incentive price-adjustment field 760e: (i) name of the product (e.g., title of product); (ii) usage of the product (e.g., any limitation on use per purchase, if none, “unlimited” is entered); (iii) pricing scheme (e.g., simple or purchase quality); (iv) pricing adjustment (e.g., percent discount, absolute, or random adjustment); and (v) amount of the price adjustment (e.g., 20% or specific $$ amount). After the foregoing information has been entered, the end user clicks on next 761 for displaying the subsequent screen on the monitor.

FIG. 7F illustrates a subsequent screen resulting from having clicked next 761 in FIG. 7E. Field 760f is represented in FIG. 7F as an incentive option field which includes a decision entry (e.g., does the end user wish to finish the incentive or create a new pricing term?), and a display of the following entries: (i) type of incentive (e.g., coupon, sale, etc.); (ii) dates of sale (e.g., “10/30/2002 12:AM-10/30/2002 11:59 PM”); (iii) distribution dates (e.g., “10/30, 2002 12:AM-10/30/2002 11:59 PM”);

(iv) max. distribution count (e.g., unlimited or limited to a specific quantity such as 10,000); and pricing term(s) (e.g., “1” representing that there is a following entry such as “$10 off $50 minimum purchase, slot 12”). After “finish this incentive” has been selected, the end user clicks next 761 to display the screen of FIG. 7G which includes a field 760g for assigning a selected campaign into product tagger after the base coupon was created (e.g., as illustrated under “definition” in FIG. 7F).

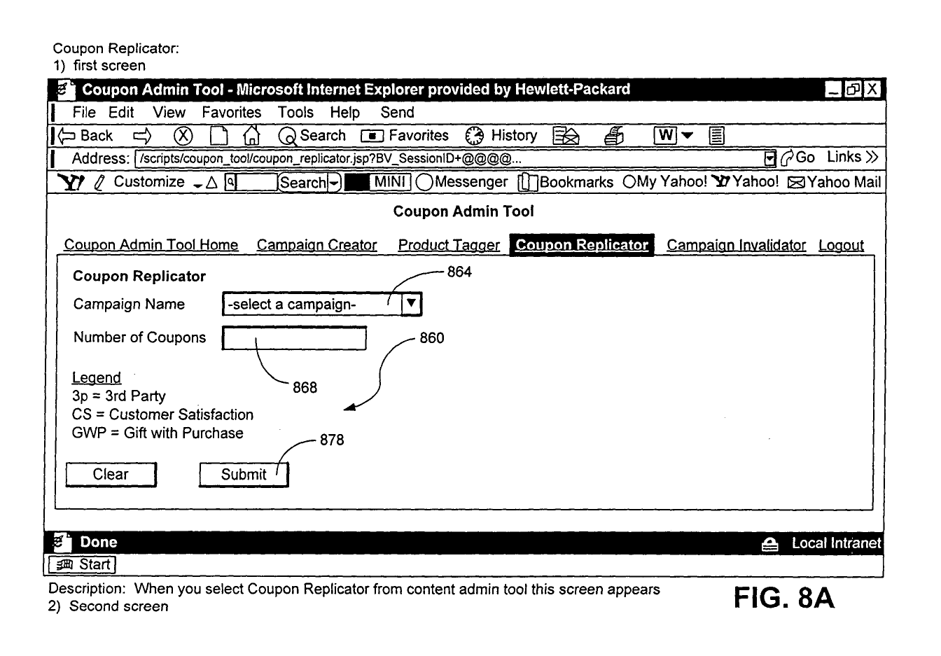

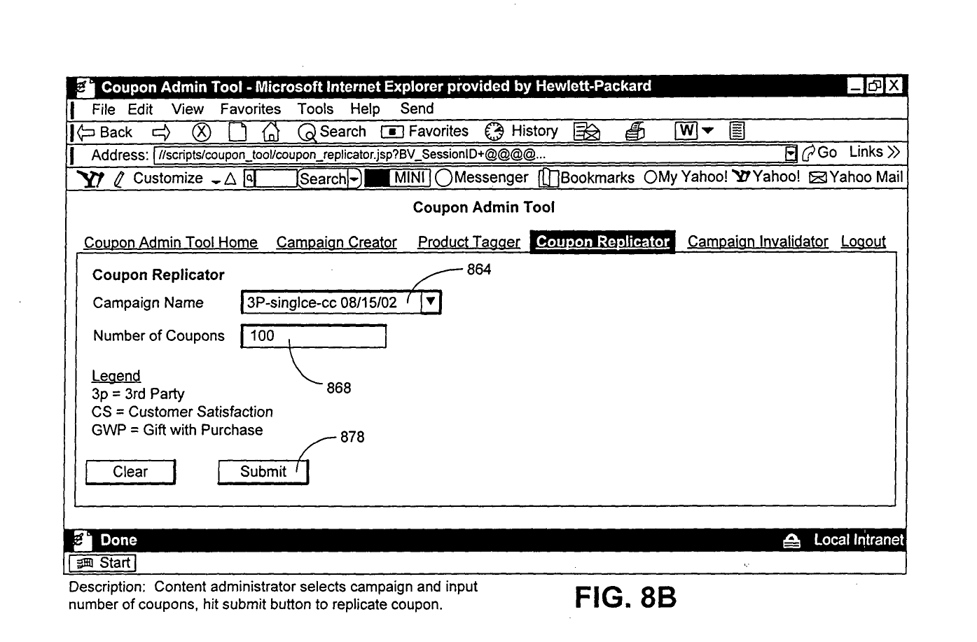

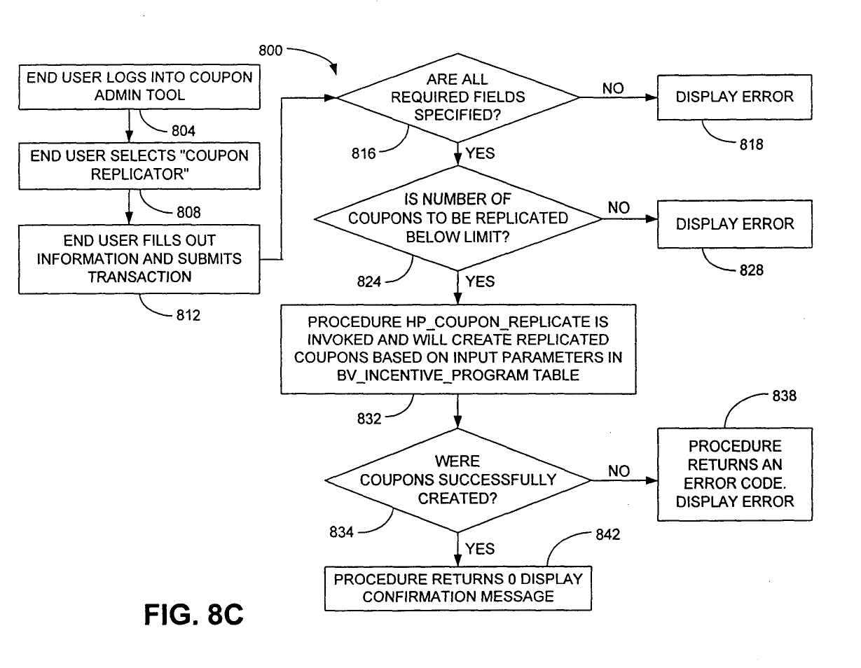

Referring again now to FIG. 4, the user (e.g., corporate content administrator) may replicate coupons from a created base coupon by clicking on or otherwise opening the icon/block designated as coupon replicator 408. When coupon replicator 408 has been opened, appropriate fields 860 are exposed as illustrated in FIG. 8A for the user to subsequently specify therein the following for replicating one or more coupons: campaign name, and number of coupons to be replicated. More specifically, and continuing to refer to FIG. 8A, fields 860 includes campaign field 864 and number coupons field 868. A campaign name (e.g., “3P-singlce-cc 08/15/02” in FIG. 8B) is assigned to the campaign field 864. The number coupons field 868 receives a number (e.g., “100” in FIG. 8B) which represents the number of coupons to be replicated.

After the end user or commercial supplier has inserted respectively the campaign name, and the number of coupons to be replicated in campaign field 864, and number coupons field 868, the end user clicks on submit 878 to successfully create the desired number of coupons. A confirmation message (e.g., “You have successfully created ..........# of coupons .........) may be displayed for confirming that the coupon replicator 408 was successfully executed. If coupons have been successfully replicated, a list of coupon codes may be displayed to the web browser via the web assembly 200. For coupon distribution to a third party vendor and in an embodiment of the invention, the end user should copy and paste list of created coupon codes to a text file, zip file with password protection, and send file via email.

Referring now to FIG. 8C there is seen a logic flow diagram 800 for replicating any desired number of coupons. The following logic will be performed by the logic flow diagram 800 of FIG. 8C: (i) if required fields are missing, an error will be displayed; (ii) if number of coupons to be replicated exceeds a pre-defined limit, an error will be displayed; (iii) when end user submits a transaction, the procedure HP_COUPON_REPLICATE will be invoked; (iv) if the procedure successfully replicated the base coupon as specified by end user, it will return “0” and a confirmation message will be displayed (also, a list of created coupons, which may be sent to a third party vendor, will be displayed to end user); and (v) if the procedure can not replicate a base coupon, it will return an error code and an error will be displayed to the end user.

More specifically with respect to the logic flow diagram 800, in block 804 the end user logs in the coupon administrator tool 400 which may be set forth or otherwise presented on one or more of the web pages 304 of the publishing system 303. When the coupon administrator tool 400 is suitably displayed, such as illustrated in FIG. 4, the user selects coupon replicator 408, as represented by block 808, to commence the process of replicating a base coupon. The user clicks on or otherwise opens the file for replicating a base coupon by clicking on 408. Subsequently as illustrated by block 812 the end user fills in the appropriate information in the required field. As indicated, the appropriate information to be submitted by the end user comprises the campaign name, and number of coupons to be replicated. After all fields have been filled out by the end user, the end user submits the transaction, such as by clicking on submit 878 in FIG. 8A, and then the logic of the computer (i.e., computer system 10 including appropriate code) determines the following: are all required fields specified as represented by decision block 816, and is the number of coupons (e.g., 1 to 10,000) to be replicated below a designated limit as represented by decision block 824.

If all required fields have not been specified or contain information, a display error will be displayed to the end user in accordance with block 818. If all required fields have been specified, then the logic of the computer will determine if the number of coupons to be replicated is below the designated specified limit, as indicated by decision block 824. If the number of coupons to be replicated is not below the designated specified limit, the computer returns an error code and displays an error, as illustrated by block 828. If the number of coupons to be replicated is below the designated specified limit, the procedure represented by block 832 is conducted; that is as seen in block 832 of FIG. 5C, “Procedure HP_COUPON_REPLICATE is invoked and will create a new campaign based on input parameters in BV_INCENTIVE_PROGRAM table”. In order to replicate coupons the input parameters in the following Table II are employed:

TABLE III
BV_INCENTIVE_PROGRAM

| | | | DESCRIP- |
|---|---|---|---|
| COLUMN | DATATYPE | CONSTRAINTS | TION |
| Campaign | Number(3) | Foreign key To | Campaign |
| id | | hp_coupon_campaigns−>id | number |
| | | | It indicates |
| | | | which cam- |
| | | | paign coupon |
| | | | belongs to |
| Issued | Number(1) | Default 0 | Flag that indi- |
| | | | cates whether |
| | | | coupon has |
| | | | already been |
| | | | issued |
| Base oid | Number(38) | | Oid of base |
| | | | coupon |
| User id | Number(38) | | User id to |
| | | | which this |
| | | | coupon has |
| | | | assigned |

Under “Column” in the foregoing Table III, the following parameters are listed: Campaign Id (i.e., campaign identification, indicating which campaign a coupon belongs), Issued (i.e., a flag that indicates whether a coupon has already been issued), Base_oid (i.e., “oid” of base coupon), and User_id (i.e., user id which was assigned to this coupon).

Under “datatype”, a number is listed. “Number(3)” corresponding to “Id” connotes a three digit number, such as “362” is FIG. 5B. “Number(1)” corresponding to “Issued” connotes a single digit number. “Number(38)” corresponding to “Base_oid” connotes a thirty-eight(38) digit number. “Number(38)” corresponding to “User_id” also connotes a thirty-eight(38) digit number.

Under “constraints” the limitations and/or constraints of the parameters listed under “column” are provided. “Foreign key to hp_coupon_campaigns→id” corresponding to “campaign_id” in Table III means its value in Table III must match one of the values for campaign ID in Table I (i.e., campaign ID under HP_COUPON_CAMPAIGNS in Table I). Also, and as indicated, under certain embodiments of the present invention, there will only be one campaign with distribution type “gift with purchase”. “Default 0” corresponding to “Issued” means its value by default is “0”. In an embodiment of the present invention and as illustrated in Table III above, “base_oid” and “user_id” have no constraints.

After the desired number of coupons have been replicated from the base coupon, the logic flow of the computer system proceeds to determine if the desired number of coupons were successfully created as represented by decision block 834. If the desired number of coupons were not successfully created, then the determination of decision block 834 will be a negative determination and an error will be displayed in accordance with block 838. If the desired number of coupons were successfully created, then the determination of decision block 834 will be a positive determination, and then the procedure returns “0” and a confirmation message will be displayed in accordance with block 842.

Thus, the coupon replication procedure will replicate a base coupon based on the following input parameters:

Campaign ID (p_campaign_id)

Number of coupons that needs to be replicated (p_number_of_coupons)

The coupon replication procedure will return the output parameter p_status with the following codes:

0 if the coupons were successfully replicated

1 if base coupon was not created

2 if more than one base coupon was created

−1 if a system error has occurred. All database changes will be rolled back.

The incentive name and coupon code for the replicated coupons will be in the following format: <campaign_id><random number>. Every replicated coupon will have the BASE_OID field set to the base coupon oid.

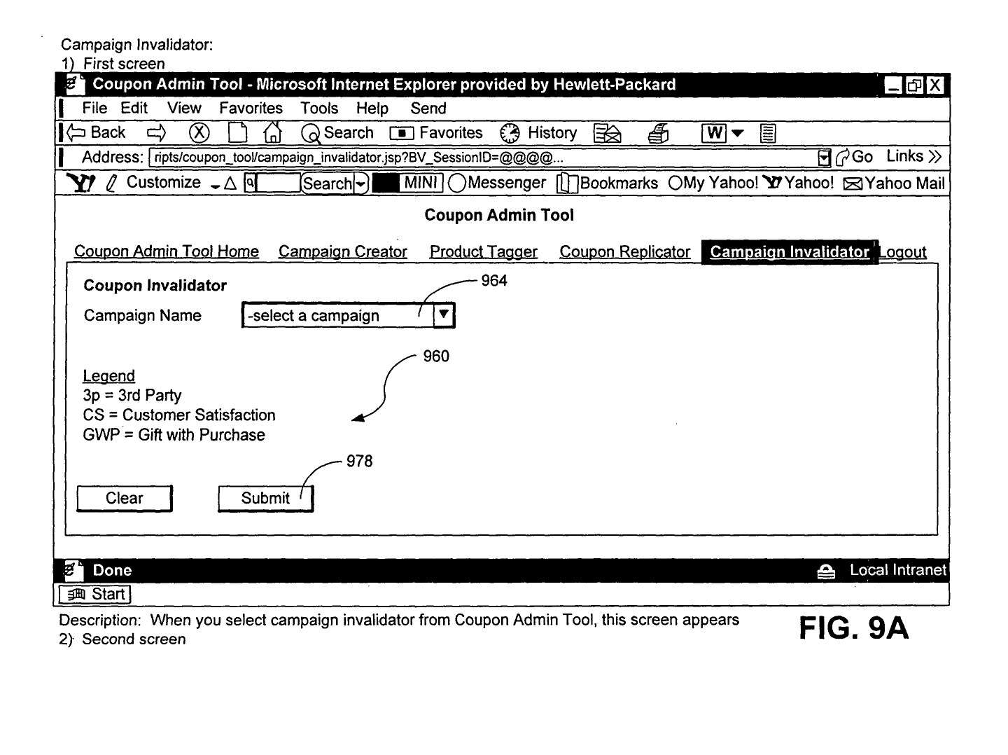

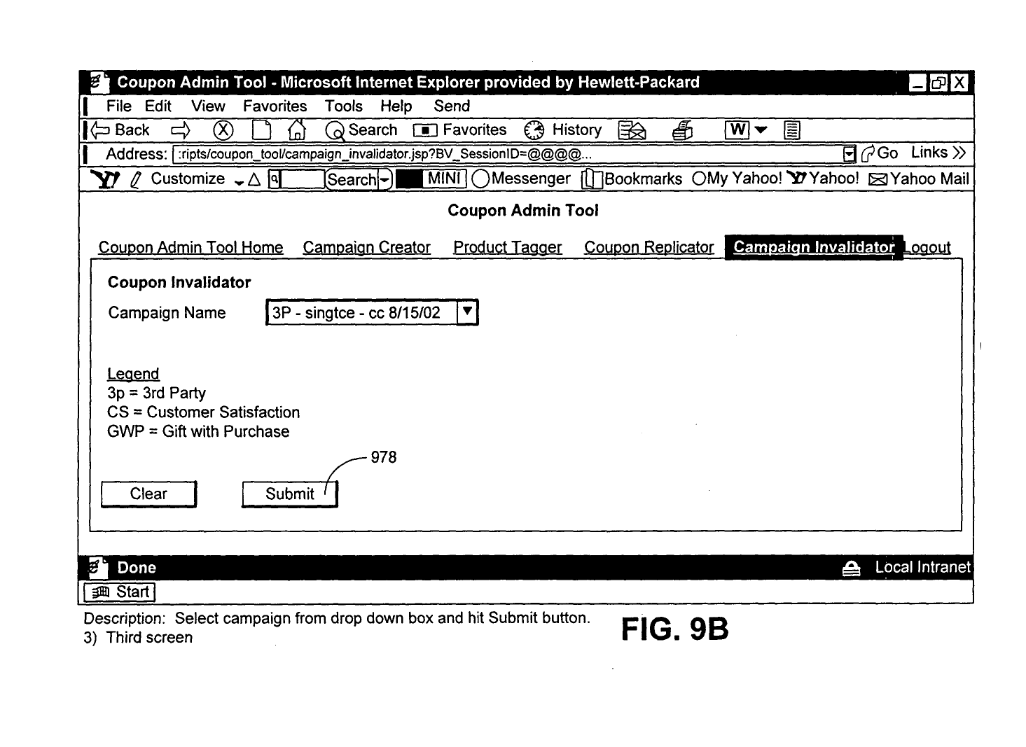

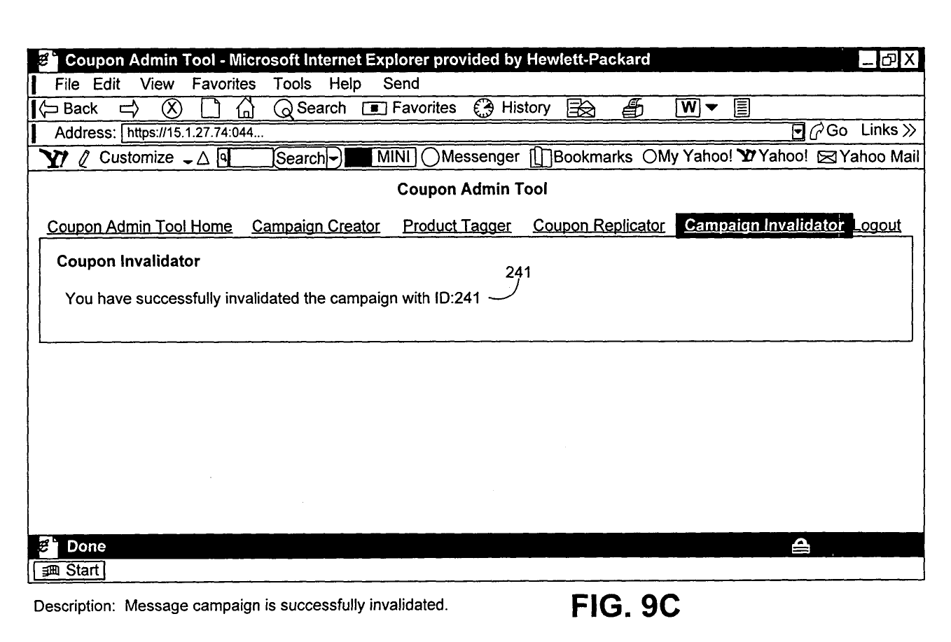

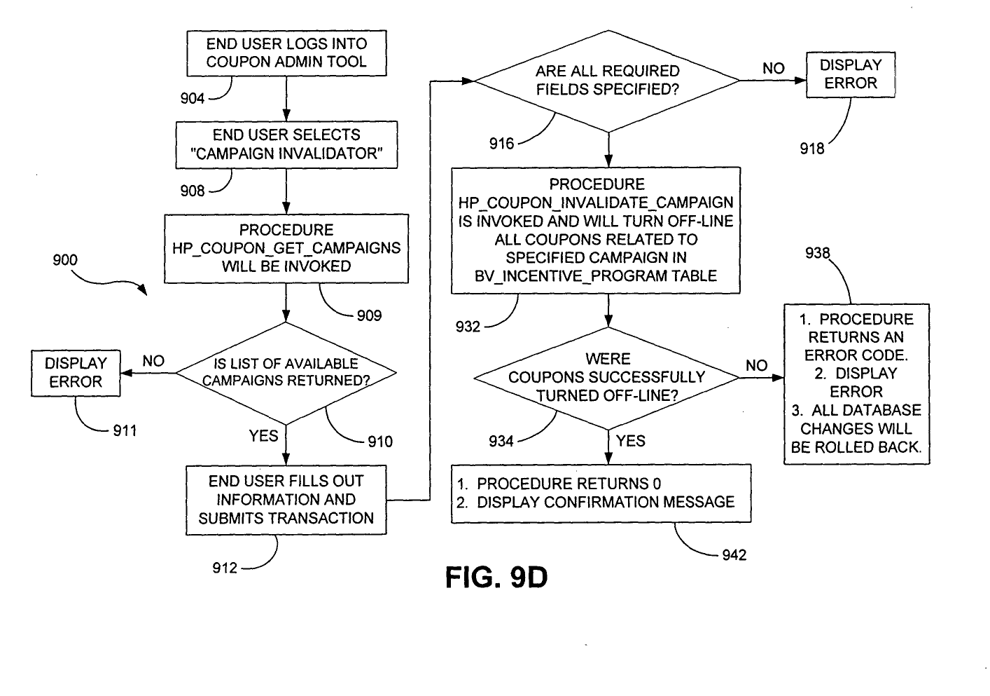

The user (e.g., corporate content administrator) may invalidate a campaign by clicking on or otherwise opening the icon/block or button designated as campaign invalidator 410 (see FIG. 4). When campaign invalidator 410 has been opened, appropriate fields 960 are exposed as illustrated in FIG. 9A for the user to subsequently specify therein the following to invalidate a campaign and all coupons associated with the campaign: campaign name. More specifically, and continuing to refer to FIG. 9A, fields 960 includes campaign field 964.

After the end user or commercial supplier has inserted respectively the campaign name (e.g., “3P-singlce-cc 08/15/02” in FIG. 9B), the end user clicks on submit 978 to successfully invalidate a campaign and all coupons associated with the campaign. As best shown in FIG. 9C, the coupon invalidator 410 as illustrated in FIG. 9A was successfully executed (see “You have successfully invalidated campaign with ID 241” in FIG. 9C).

Referring now to FIG. 9D there is seen a logic flow diagram 900 for invalidating a campaign and any desired number of coupons associated with the campaign. The following logic will be performed by the logic flow diagram 900 of FIG. 9D: (i) the procedure HP_COUPON_GET_CAMPAIGNS will be invoked so that all the available campaigns are displayed in drop-down list; (ii) if end user does not select a campaign from drop-down list, an error will be displayed; (iii) when end user submits the transaction, the procedure HP_COUPON_INVALIDATE_CAMPAIGN will be invoked to turn off-line all coupons related to selected campaign in the BV_INCENTIVE_PROGRAM table; (iv) if the procedure runs successfully, it will return “0” and a confirmation message will be displayed; and (v) if the procedure did not run successfully, it will return an error code and an error message will be displayed to the end user.

More specifically with respect to the logic flow diagram 900, in block 904 the end user logs in the coupon administrator tool 400 which may be set forth or otherwise presented on one or more of the web pages 304 of the publishing system 303. When the coupon administrator tool 400 is suitably displayed, such as illustrated in FIG. 4, the user selects coupon invalidator 410, as represented by block 908, to commence the process of invalidating a campaign and all coupons associated with the campaign. The user clicks on or otherwise opens the file for invalidating campaigns and associated coupons by clicking on 410. Subsequently, the end user invokes the procedure HP_COUPON_GET_CAMPAIGNS as represented by block 909 by clicking on a submit button so that all the available campaigns are displayed in a drop-down list. Then the logic flow determines if all available campaigns have been displayed, as illustrated by decision block 910 which is labeled: “Is list of available campaigns returned?”

If the list of all available campaigns are not returned and displayed, a display error will be displayed to the end user in accordance with block 911. If the list of all available campaigns are returned and displayed, the logic flow proceeds to block 912 where the end user fills in the appropriate information in the required field and submits the invalidation transaction. As indicated, the appropriate information to be submitted by the end user comprises the campaign name. After all fields have been filled out by the end user, the end user submits the transaction, such as by clicking on submit 978 in FIG. 9A, and then the logic of the computer (i.e., computer system 10 including appropriate code) determines if all required fields have been specified as represented by decision block 916. If all required fields have not been specified or contain information, a display error will be displayed to the end user in accordance with block 918. If all required fields have been specified, then the logic of the computer will proceed with conducting the procedure represented by block 932; that is as seen in block 932 of FIG. 9D, “Procedure HP_COUPON_INVALIDATE_CAMPAIGN is invoked and will turn off-line all coupons related to specified campaign in BV_INCENTIVE_PROGRAM table”. As previously mentioned above, Table III represents the information (e.g., campaign id) for the BV_INCENTIVE_PROGRAM.

After the procedure represented by block 932 has been conducted, the logic flow of the computer system proceeds to determine if the desired number of coupons were successfully turned off-line, as represented by decision block 934. If the desired number of coupons were not successfully turned off-line, then the determination of decision block 934 will be a negative determination, and an error will be displayed in accordance with block 938 along with rolling back all database changes. More specifically, if the determination of decision block 934 is a negative determination, then in accordance with block 938: “1. Procedure returns an error code. 2. Display error. 3. All database changes will be rolled back.” If the desired number of coupons were successfully turned off-line, then the determination of decision block 934 will be a positive determination, and then the procedure returns “0” and a confirmation message will be displayed in accordance with block 942.

Thus, the coupon-get campaign procedure will return a list of available campaign Ids based on the following parameter:

Distribution type (p_distribution_type)

The coupon-get campaign procedure will return the output parameter p_status with the following:

Empty string if no campaign is available for specified distribution type

List of campaign Ids separated by comma

−1 if a system error has occurred

Thus further, the coupon-invalidate campaign procedure will accept the following input parameter:

Campaign ID (p_campaign_id)

The procedure will turn off-line all coupons related to campaign ID specified in the input parameter. The coupon-invalidate campaign procedure will return the output parameter p_status with the following:

0 if all coupons related to specified campaign have been successfully invalidated

−1 if a system error has occurred

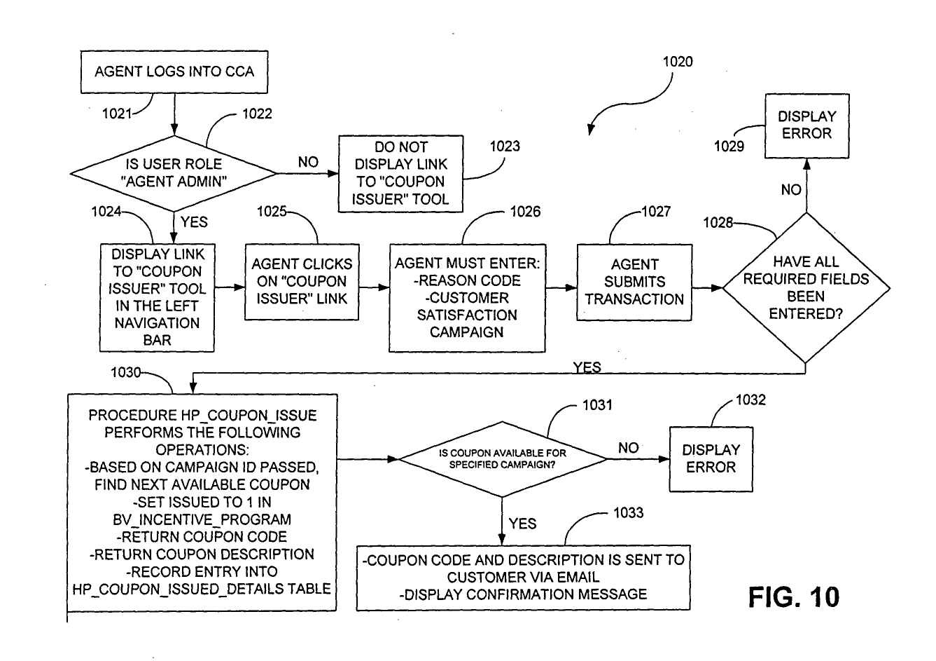

Referring now to FIG. 10 there is seen a logic flow diagram, generally illustrated as 1020, of a cost center application (CCA) tool. The information for producing and opening, exposing and using the CCA tool would be stored in data storage device 18 and/or memory 16 of the computer system 10. The CCA tool may be used by any person or entity (e.g., a cost center agent or agent administrator of any commercial supplier such as Hewlett Packard, etc) for any of the embodiments of the present invention, such as issuing one or more coupons, re-issuing one or more coupons, and redeeming one or more coupons. The CCA tool would typically be available through a suitable display, such as on the monitor 34 of the computer system 10 of FIG. 1, and may include the following icons or buttons: coupon issuer 1002, coupon re-issuer 1004, and coupon redeemer 1010. The CCA tool enables a user (e.g., a cost center agent of a commercial supplier) to perform the following functionalities (e.g., in a left navigation bar in the CCA tool): (i) issuing a coupon (e.g., a coupon related to a particular campaign; (ii) re-issuing a coupon (e.g., a coupon related to a particular campaign); and (iii) redeeming a coupon.

The user (e.g., cost center agent or agent administrator) may issue a coupon through the functionality available in left navigation bar in the CCA tool and by clicking on or otherwise opening the button or block designated as coupon issuer. When coupon issuer has been opened, appropriate fields are exposed to subsequently specify therein the following: campaign name, reason description, and order number. Thus, fields includes campaign field, reason description field, and order number field.

The campaign field receives a campaign name from the cost center agent or agent administrator. This field typically includes an input text field and may receive any suitable number of characters, such as 100 or less. The campaign name may be any suitable name, such as “$10 coupon when you buy HP Laser Jet 1200” as illustrated in FIG. 5A. The reason description field receives a description of the coupon(s) to be issued. The order number field is assigned an order number by the cost center agent.

After the end user (i.e., the cost center agent) has inserted respectively the campaign name, and the reason description, and the order number in campaign field, the reason description field, and the order number field, the end user clicks on an appropriate submit button to successfully issue the desired number of coupons. An appropriate confirmation message may be displayed (e.g., “You have successfully issued coupons”).

Referring again now to FIG. 10 the following logic will be performed by the logic flow diagram 1020 for issuing any desired number of coupons: (i) after an end user enters an order number, if the order number does not exist in the database, an error message will be displayed; if the order number does exists, input fields are displayed with the email pre-filled from the BV_USER_PROFILE table if available (note: if there is no email in the profile, an error will be displayed); (ii) the procedure HP_COUPON_GET_CAMPAIGNS will be invoked so that all “customer satisfaction” campaigns are displayed in drop-down list; (iii) if required fields are missing, an error is displayed; (iv) when end user submits the transaction, the procedure HP_COUPON_ISSUE is invoked so that the next available coupon will be returned along with the coupon description, and the invoked procedure will store an entry into the HP_COUPON_ISSUED_DETAILS table and set the “ISSUED” bit in the BV_INCENTIVE_PROGRAM table to 1; (v) if the invoked procedure successfully runs, it will return the coupon code and coupon description, both of which will be transmitted (e.g., by email) to the customer; and (vi) if the invoked procedure does not find an available coupon related to the specified campaign and cannot insert an entry into the HP_COUPON_ISSUED_DETAILS table, it will return an error code and an error will be displayed to the end user.

More specifically with respect to the logic flow diagram 1020, in block 1021 the end user logs in the CCA tool which may be set forth or otherwise presented on one or more of the web pages 304 of the publishing system 303. When the CCA tool is suitably displayed, the logic flow then tests or determines in decision block 1022 if the user (e.g., the cost center agent) is an “Agent Admin”. If the test or determination by decision block 1022 is negative, then the link to “coupon issuer” tool is not displayed, as illustrated by block 1023. If the test or determination by decision block 1022 is positive, then the link to “coupon issuer” tool in the left navigation bar is displayed. Subsequently, the user selects coupon issuer button, as represented by block 1025, to commence the process of issuing a coupon.

The user clicks on or otherwise opens the file for issuing a coupon by clicking on coupon issuer button. Subsequently as illustrated by block 1026 the end user fills in the appropriate information in the required field. As indicated, the appropriate information to be submitted by the end user comprises the campaign name, reason description, and order number of coupon(s) to be issued. After all fields have been filled out by the end user, the end user submits the transaction as represented by block 1027, such as by clicking on an appropriate submit button, and then the logic of the computer (i.e., computer system 10 including appropriate code) determines if all required fields have been entered as represented by decision block 1028. If all required fields have not been specified or contain information, a display error will be displayed to the end user in accordance with block 1029. If all required fields have been specified, then the logic of the computer will proceed to the procedure represented by block 1030; that is as seen in block 1030 of FIG. 10: “Procedure HP_COUPON_ISSUE performs the following operations: -based on campaign id passed, find next available coupon-set ISSUED to 1 in BV_INCENTIVE_PROGRAM-return coupon code-return coupon description-recordentry into HP_COUPON_ISSUED_DETAILS table”. In order to issue coupon(s) the input parameters in the following Table III are employed:

TABLE IV
HP_COUPON_ISSUED_DETAILS

| | | CON- | |
|---|---|---|---|
| COLUMN | DATATYPE | STRAINTS | DESCRIPTION |
| Id | Number(38) | Primary key | Transaction ID |
| | | Create | |
| | | sequence | |
| Coupon_oid | Number(38) | | Oid of coupon into |
| | | | bv_incentive_program |
| Agent_id | Number(38) | | Call center agent who |
| | | | issued coupon |
| Issued_date | Date | | Date coupon was |
| | | | issued |
| Email | Varchar2(50) | | Email person to |
| | | | whom agent issued |
| | | | coupon |
| Reason | Varchar2(500) | | Reason why coupon |
| | | | was issued |
| Order Number | Varchar2(25) | | Order number |

Under “Column” in the foregoing Table IV, the following parameters are listed: Id (i.e., transaction identification); coupon_oid (i.e., oid of coupon into by_incentive_program); agent_id (i.e., call center agent who issued coupon); issued date (i.e., date coupon was issued); Email (i.e., Email of person to whom agent issued coupon); reason (i.e., reason why coupon was issued); and order number (i.e., the order number for issued coupon).

Under “datatype”, either a number or date or “varchar” (various or alphanumeric characters) is listed. “Number (38)” respectively corresponding to “Id”, “coupon_oid,” and “agent_id” connotes a thirty-eight (38) digit number. Date corresponding to “Issued_date” connotes the date of issue of the coupon(s). “Varchar2(50)” corresponding to “Email” is a string having a limit of fifty characters. “Varchar2(500)” corresponding to “reason” connotes a string having a limit of five hundred characters. “Varchar2(25) corresponding to “order number” connotes a string having a limit of twenty five characters.

Under “constraints” the limitations and/or constraints of the parameters listed under “column” are provided. “Primary key to Create sequence” corresponding to “Id” in Table IV means a unique ID value. In an embodiment of the present invention and as illustrated in Table IV above, “coupon_id”, “agent_id”, “issued_date”, “Email”, “reason” and “order number” have no constraints.

After the desired number of coupons have been issued, the logic flow of the computer system proceeds to determine if the desired number of coupons is/are available for the specified campaign as represented by decision block 1031. If the desired number of coupons is/are not available for the specified campaign, then the determination of decision block 1031 will be a negative determination and an error will be displayed in accordance with block 1032. If the desired number of coupons is/are available for the specified campaign, then the determination of decision block 1031 will be a positive determination, and then the coupon code and description is sent to the customer via Email and a confirmation message will be displayed, all in accordance with block 1033.

Thus, the coupon-issue procedure will return the next available coupon based on the following parameters:

Campaign ID (p_campaign_id)

Agent ID (p_agent_id), for Gift with Purchase campaigns, agent id is 0

Email (p_email)

Reason (p_reason), for Gift with Purchase campaigns, reason is “Gift with Purchase”

Order number (p_order_number)

User ID (p_user_id)

The coupon-issue procedure will return the following output parameters:

Coupon code if available (p_status). Once a coupon code is available, an entry will be created in the HP_COUPON_ISSUED_DETAILS table.

1 if no coupon is available for selected campaign (p_status)

−1 if a system error has occurred (p_status)

Description (p_description). If description is not available, return

The user (e.g., center agent or agent administrator) may re-issue a coupon through the functionality available in left navigation bar in CCA tool and by clicking on or otherwise opening the icon/block/button designated as coupon re-issuer. When coupon re-issuer has been opened, appropriate fields are exposed as illustrated illustrated in other embodiments of the invention to subsequently specify therein the Email address(es), particularly the Email address(es) of any customer which will be receiving re-issued coupons. More specifically, appropriate fields includes Email field.

The Email field receives an Email address from the cost center agent or agent administrator. After the end user (i.e., the center agent) has inserted the E-mail address, the end user clicks on a submit button to successfully re-issue the desired number of coupons. A confirmation message (e.g., “You have successfully reissued # of coupons) may be displayed to confirm that the coupon re-issuer was successfully executed and re-issued the desired number of coupons.

In an embodiment of the invention, only agents with profile COUPON_ISSUER set to 1 will be able to re-issue a coupon to a customer, per a similarity to the logic flow diagram 1020 (e.g., instructions of block 1030) of FIG. 10 for issuing coupons. Once a call center agent submits the Email, all coupons that were issued from the coupon issuer tool (i.e. the coupons resulting from the logic flow diagram 1020 in FIG. 10) to any specified email address will be displayed. The call center agent will select a coupon and submit the transaction. In an embodiment of the invention, only coupons that are still available may be reissued, and an Email will be sent to a customer with the coupon code and description, all to affirm that a coupon has been re-issued. The logic flow diagram for re-issuing coupons is essentially the same as the logic flow diagram 1020 for issuing one or more coupons.

The user (e.g., center agent or agent administrator) may redeem a coupon through the functionality available in left navigation bar the CCA tool and by clicking on or otherwise opening the icon/block/button designated as coupon redeemer. When coupon redeemer has been opened, appropriate fields in a check out page are exposed as illustrated in other embodiments of the invention to subsequently specify therein the following: a coupon for redemption. Thus, appropriate fields include a coupon redemption field. As indicated, the coupon redemption field receives a coupon name from the cost center agent or agent administrator. This field typically includes an input text field and may receive any suitable number of characters, such as 100 or less. The coupon name may be any suitable name, such as “$10 coupon when you buy........... .”

After the end user (i.e., the cost center agent) has inserted the coupon name in coupon field, the end user clicks on an appropriate submit button to successfully redeem the desired number of coupons. A confirmation message (see “You have successfully redeemed ..........# of coupons) may be suitably displayed to reflect that the coupon redeemer successfully redeemed the desired number of coupons.

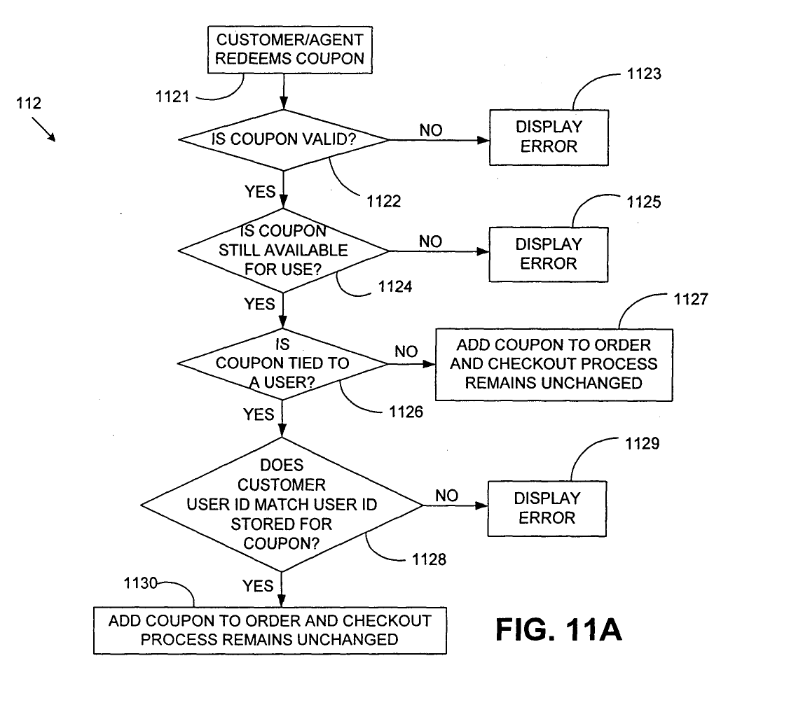

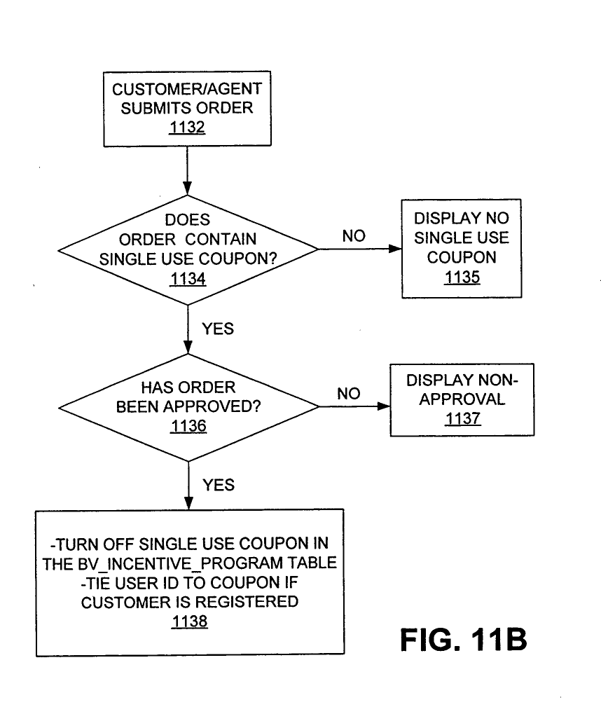

Referring now to FIG. 11 there is seen a logic flow diagram 1112 for redeeming any desired number of coupons. The following logic will be performed by the logic flow diagram 1112 of FIG. 11: (i) check to determine if coupon code is invalid; (ii) check if coupon has expired; (iii) for tied coupons, check if customer's user ID matches with the coupon's user ID; and (iv) if order is approved and a single use coupon has been used in the order, a trigger will be invoked and will invalidate the single use coupon by turning it off-line for ensuring that the single use coupon will only be used once provided the order has been approved.

More specifically with respect to the logic flow diagram 1112, in block 1121 the end user logs in the CCA tool which may be set forth or otherwise presented on one or more of the web pages 304 of the publishing system 303. The CCA tool may be suitably displayed. After the instructions reflected by block 1121, the logic flow then tests or determines in decision block 1122 if the coupon is valid. If the test or determination by decision block 1122 is negative, then, as illustrated by block 1123, an error is displayed. If the test or determination by decision block 1122 is positive, then the logic flow proceeds to decision block 1124 for determining if the coupon is still available for use. If the test or determination by decision block 1124 is negative, then, as illustrated by block 1125, an error is displayed. If the test or determination by decision block 1124 is positive, then the logic flow proceeds to decision block 1126 for determining if the coupon is tied to a user. If it is determined in accordance with decision block 1126 that the coupon is not tied to a user, then the coupon is added to the order and the checkout process remains unchanged, all as represented by block 1127. If it is determined in accordance with decision block 1126 that the coupon is tied to a user, then the logic flow proceeds to decision block 1128 for determining if customer user ID matches the user ID stored for coupon. If it does not, an error is displayed in accordance with block 1129. If there is a match, then the logic flow proceeds to block 1130 which represents adding “coupon to order and checkout process remains unchanged.” Subsequently, the user/customer-agent submits the order, as represented by block 1132, by clicking on an appropriate submit button to commence the process of submitting the order. After the order is submitted, the logic flow proceeds to decision block 1134 for determining if the order contains a single use coupon. If the determination in accordance with decision block 1134 is “no”, then this decision or determination is displayed in accordance with block 1135 (i.e., “Display No Single Use Coupon”). If the determination in accordance with decision block 1134 is “yes”, then the logic flow proceeds to decision block 1136 for determining if the order has been approved. If there is no approval of the order, then non-approval is displayed in accordance with block 1137 (i.e., “Display Non-Approval”). If the order is approved, then the logic flow proceeds to the procedure of block 1138 which specifically states: “-Turn off single use coupon in the BV_INCENTIVE_PROGRAM table, -Tie user id to coupon if customer is registered”.

In another embodiment of the invention, a configure to order (CTO) product creation system and method is provided to allow coupons to be used against CTO configured systems. When a CTO configured system is added to a database, such as data storage device 18 and/or memory 16 of the computer system 10 in FIG. 1, the CTO bundle and bundle items will be tagged with the campaign values stored for CTO base product. This means that the configured system will be able to receive a same discount as the CTO base model.

A logic flow diagram may be provided for creating in the database CTO bundle and bundle items when a customer adds a CTO configured system to the shopping cart. The following logic will be performed by a suitable logic flow diagram: (i) the procedure HP_COUPON_GET_CTO_BASE_PROPS will be invoked so that CTO bundle and bundle items will be tagged with the campaign values stored for CTO base product during the creation of those products; and (ii) if the procedure successfully gets the property name list and value list, the return status will be 0; and a comma delimited list of campaign/coupon field names and values are returned (otherwise, it will return −1 and an error will be displayed).

Thus, the CTO product creation procedure will accept the following input parameter:

Base CTO product ID (p_base_cto_prod_id)

The CTO product creation procedure will return the coupon/campaign property names and values for the CTO base product so that the CTO bundle and bundle items can be properly tagged with the coupon/campaign values. This will enable correct discount calculations for CTO products.

The CTO product creation procedure will return the output parameter p_status with the following values:

0 if the coupon/campaign property names and values for the CTO base products were successfully retrieved

−1 if a system error has occurred

If CTO product creation procedure ran successfully, it will also return the following output parameters:

p_coupon_campaign_number_list-comma delimited list of coupon/campaign property field names

p_coupon_campaign_value_list-comma delimited list of coupon/campaign property field values

In another embodiment of the invention, a campaign may be archived after it has expired by clicking on or otherwise opening the icon/block/button designated as campaign archiver. Once a campaign has expired, the following items will need to be archived: (i) all coupon entries related to the campaign will be removed from the BV_INCENTIVE_PROGRAM table and will be moved to an archive table identified below as “Table V HP_ARC_INCENTIVE_PROGRAM”; (ii) the campaign entry in the HP_COUPON_CAMPAIGNS table will be removed and will be moved to an archive table identified below as “Table VI HP_ARC_COUPON_CAMPAIGNS”; and (iii) all entries related to the campaign will be removed from the HP_COUPON_ISSUED_DETAILS table and will be moved to an archive table identified below as “Table VII HP_ARC_COUPON_ISSUED DETAILS”.

TABLE V
HP_ARC_INCENTIVE_PROGRAM

| | | | DESCRIP- |
|---|---|---|---|
| COLUMN | DATATYPE | CONSTRAINTS | TION |
| Campaign | Number(3) | Foreign key To | Campaign |
| id | | hp_coupon_campaigns−>id | number |
| | | | It indicates |
| | | | which cam- |
| | | | paign coupon |
| | | | belongs to |
| Issued | Number(1) | Default 0 | Flag that indi- |
| | | | cates whether |
| | | | coupon has |
| | | | already been |
| | | | issued |
| Base oid | Number(38) | | Oid of base |
| | | | coupon |
| User id | Number(38) | | User id to |
| | | | which this |
| | | | coupon has |
| | | | assigned |

TABLE VI
HP_ARC_COUPON_CAMPAIGNS

| COLUMN | DATATYPE | CONSTRAINTS | DESCRIPTION |
|---|---|---|---|
| Id | Number(3) | Primary key | Campaign id |
| | | Create sequence | |
| Description | Varchar2(100) | | Description |
| Distribution | Number(2) | Foreign key to hp | Possible values: |
| Type | | coupon distribution | 3^{rd} party |
| | | types−>type | Customer satisfac- |
| | | | tion |
| | | | Gift with purchase |
| Product ID | Varchar2(80) | | Product ID that is |
| | | | tied to “Gift with |
| | | | purchase” campaign |
| Priority | Number(2) | Default 0 | If there is more than |
| | | | one “Gift with |
| | | | purchase” campaign |
| | | | applicable to order, |
| | | | this field will be |
| | | | used to select which |
| | | | coupon campaign |
| | | | will be attached to |
| | | | order |
| Status | Number(2) | Default 1 | Indicate whether |
| | | | campaign is active |

TABLE VII
HP_ARC_COUPON_ISSUED_DETAILS

| | | CON- | |
|---|---|---|---|
| COLUMN | DATATYPE | STRAINTS | DESCRIPTION |
| Id | Number(38) | Primary key | Transaction ID |
| | | Create | |
| | | sequence | |
| Coupon_oid | Number(38) | | Oid of coupon into |
| | | | bv_incentive_program |
| Agent_id | Number(38) | | Call center agent who |
| | | | issued coupon |
| Issued_date | Date | | Date coupon was |
| | | | issued |
| Email | Varchar2(50) | | Email person to |
| | | | whom agent issued |
| | | | coupon |
| Reason | Varchar2(500) | | Reason why coupon |
| | | | was issued |
| Order Number | Varchar2(25) | | Order number |

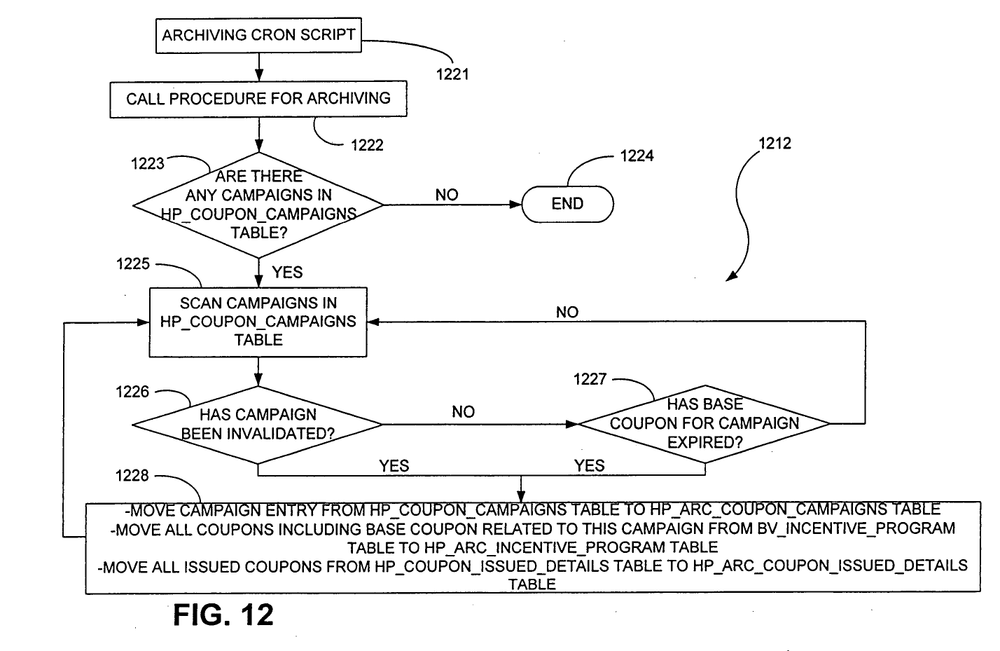

Referring now to FIG. 12 there is seen a logic flow diagram 1212 for archiving any desired number of campaigns. There will be a check that scans all campaigns stored in the HP_COUPON_CAMPAIGNS table. If a campaign has been invalidated, the following logic will be performed by the logic flow diagram 1212 of FIG. 12: (i) move campaign from HP_COUPON_CAMPAIGNS table to HP_ARC_COUPON_CAMPAIGNS table;

(ii) move all coupons related to a particular campaign from BV_INCENTIVE_PROGRAM table to HP_ARC_INCENTIVE_PROGRAM table; and (iii) move issued coupon entries from HP_COUPON_ISSUED_DETAILS table to HP_ARC_COUPON_ISSUED_DETAILS table. If a campaign has not been invalidated and the base coupon related to the campaign has expired, the following logic will be performed by the logic flow diagram 1212 of FIG. 12: (i) move campaign from HP_COUPON_CAMPAIGNS table to HP_ARC COUPON CAMPAIGNS table; (ii) move all coupons related to a particular campaign from BV_INCENTIVE_PROGRAM table to HP_ARC_INCENTIVE_PROGRAM table; and (iii) move issued coupon entries from HP_COUPON_ISSUED_DETAILS table to HP_ARC_COUPON_ISSUED_DETAILS table.

More specifically with respect to the logic flow diagram 1212 for a scheduled archiving process represented by block 1221, the logic flow then calls the procedure for archiving, as illustrated by block 1222. After the procedure for archiving has been called in accordance with block 1222, the logic flow in FIG. 12 then proceeds to decision block 1223 for determining if there are any campaigns in the HP_COUPON_CAMPAIGNS table available for archiving. If there are no campaigns available for archiving, the archiving procedure terminates in accordance with block 1224. If campaigns are available for archiving, the logic flow in FIG. 12 subsequently proceeds to block 1225 where campaigns are scanned in the HP_COUPON_CAMPAIGNS table, and then to decision block 1226 for determining if a particular campaign has been invalidated. If the test or determination by decision block 1226 is negative or “no”, the logic flow in FIG. 12 then proceeds to decision block 1227 for determining if a particular base coupon has expired. If the particular base coupon has not expired, then the logic flow of FIG. 12 proceeds to or returns back to the scanning procedure represented by block 1225.

If a positive determination (i.e., a “yes”) is made by decision block 1226 or decision block 1227, then the logic flow proceeds to conduct the procedure represented by block 1228; that is: “-Move campaign entry from hp_coupon_campaigns table to hp_arc_acoupon_campaigns table, -Move all coupons including base coupon related to this campaign from by_incentive_program table to hp_arc_incentive_program table, -Move all issued coupons from hp_coupon_issued_details table to hp_arc_coupon_issued_details table”. If all campaigns have been scanned, the procedure terminates after the instructions in block 1228.

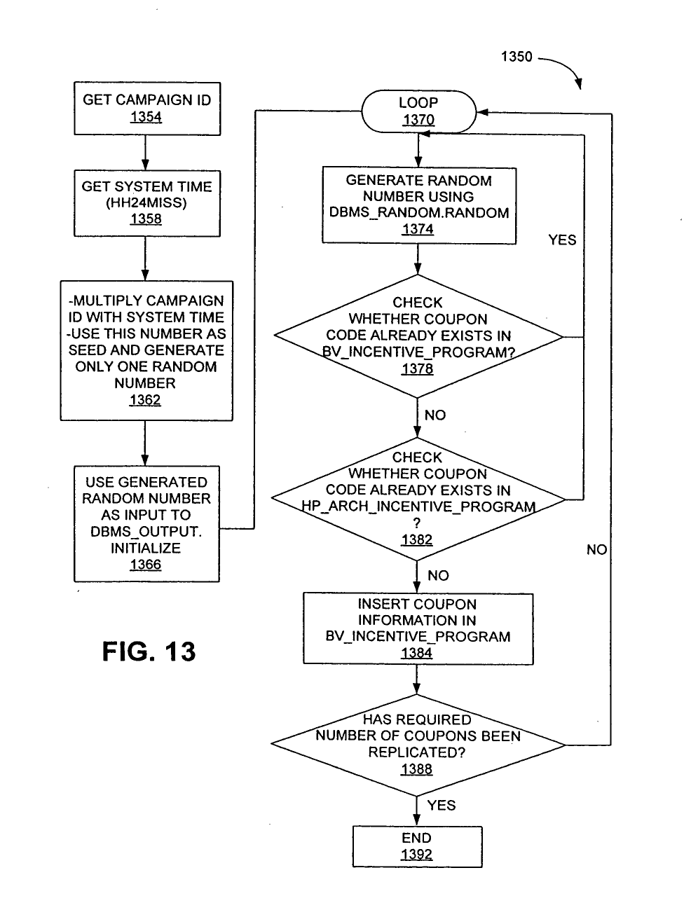

Referring now to FIG. 13 there is seen another embodiment of the invention for replicating coupon(s) and/or generating coupon codes. The following logic and procedure will be performed by the logic flow diagram 1350 of FIG. 13: (i) get campaign ID; (ii) get system time; (iii) multiply campaign ID with system time; (iv) use the value of (campaign ID x system time) as seed to generate one random number; (v) use the generated random number as input to a suitably commercially available system, such as “Linchor” by Oracle (identified in FIG. 13 as “dbms_random.random”); (vi) generate random number using a suitably commercially available system, such as “Linchor” by Oracle (identified as previously indicated in FIG. 13 as “dbms_random.random”); (vii) if coupon code generated does not exist in BV_INCENTIVE_PROGRAM and HP_ARC_INCENTIVE_PROGRAM, then the coupon will be created in BV_INCENTIVE_PROGRAM; and (viii) if coupon code generated exists in BV_INCENTIVE_PROGRAM or HP_ARC_INCENTIVE_PROGRAM, then generate another random number and repeat the process.

More specifically with respect to the logic flow diagram 1350, the end user logs in the coupon administrator tool 400 which, as previously indicated, may be set forth or otherwise presented on one or more of the web pages 304 of the publishing system 303. When the coupon administrator tool 400 is suitably displayed, such as illustrated in FIG. 4, the user selects a coupon replicator (e.g., coupon replicator 408) to commence the process of replicating a base coupon. The user clicks on or otherwise opens the file for replicating a base coupon by clicking on coupon replicator. Subsequently and as previously indicated, the end user fills in the appropriate information in the required fields. As also indicated, the appropriate information to be submitted by the end user comprises the campaign name, and number of coupons to be replicated. After all fields have been filled out by the end user, the end user submits the transaction, such as by clicking on an appropriate submit button, and then the logic of the computer (i.e., computer system 10 including appropriate code) determines the following: are all required fields specified, and is the number of coupons to be replicated below a designated limit.

If all required fields have not been specified or contain information, a display error will be displayed to the end user. If all required fields have been specified, then the logic of the computer (i.e., computer system 10 including appropriate code) respectively obtains and/or determines the campaign ID and system time in accordance with respective blocks 1354 and 1358. Subsequently, as represented by block 1362, the campaign ID is multiplied by the system time to obtain a number which is used as a seed to generate a random number. The generated random number is then employed as input into dbms_output.initialize (a previously identified commercially available software system, such as “Linchor” to Oracle.

After dbms_output.initialize receives the random number input, the logic proceeds to the beginning of a loop, as illustrated by block 1370 From loop 1370 the logic of the computer proceeds to generate a random number using dbms_random.random, as represented by block 1374. After a random number has been generated, an initial determination is made by decision block 1378 and a subsequent determination is made by decision block 1382 if the initial determination by decision block 1378 was negative (i.e., “no”). More specifically, the determination represented by decision block 1378 is whether a coupon code already exists in bv_incentive_program. If no coupon code already exists, then the determination represented by decision block 1382 is conducted; that is: whether the coupon code already exists in hp_arch_incentive_program. If the coupon code already exists in bv_incentive_program or in hp_arch_incentive_program (i.e., the determination was “yes” by decision block 1378 or by decision block 1382), then the flow of logic returns back to block 1374 to generate another random number and another determination by decision blocks 1378 and 1382. The procedure will continue to generate a new random number until the generated random coupon code does not exist in both by_incentive_program and hp_arch_inventive_program.

If the determination in accordance with decision block 1382 is a negative determination (i.e., “no”), then the logic flow proceeds to block 1384 where coupon information is inserted in BV_INCENTIVE_PROGRAM. After the coupon information has been inserted in accordance with the instructions in block 1384, the logic flow then proceeds to decision block 1388 for determining if the required number of coupons have been replicated. If there has been a replication of the required number of coupons, the logic flow terminates in accordance with block 1392. If the required number of coupons has not been replicated, then the logic flow returns to loop 1370 for repeating the procedure. The entire procedure will stop once all coupons have been replicated (determined by the specified number of coupons to be replicated).

Reference throughout this specification to “one embodiment”, “an embodiment”, or “a specific embodiment” means that a particular feature, structure, or characteristic described in connection with the embodiment is included in at least one embodiment of the present invention and not necessarily in all embodiments. Thus, respective appearances of the phrases “in one embodiment”, “in an embodiment”, or “in a specific embodiment” in various places throughout this specification are not necessarily referring to the same embodiment. Furthermore, the particular features, structures, or characteristics of any specific embodiment of the present invention may be combined in any suitable manner with one or more other embodiments. It is to be understood that other variations and modifications of the embodiments of the present invention described and illustrated herein are possible in light of the teachings herein and are to be considered as part of the spirit and scope of the present invention.

Further, at least some of the components of an embodiment of the invention may be implemented by using a programmed general purpose digital computer, by using application specific integrated circuits, programmable logic devices, or field programmable gate arrays, or by using a network of interconnected components and circuits. Connections may be wired, wireless, by modem, and the like.

It will also be appreciated that one or more of the elements depicted in the drawings/figures can also be implemented in a more separated or integrated manner, or even removed or rendered as inoperable in certain cases, as is useful in accordance with a particular application. It is also within the spirit and scope of the present invention to implement a program or code that can be stored in a machine-readable medium to permit a computer to perform any of the methods described above.

Additionally, any signal arrows in the drawings/Figures should be considered only as exemplary, and not limiting, unless otherwise specifically noted. Furthermore, the term “or” as used herein is generally intended to mean “and/or” unless otherwise indicated. Combinations of components or steps will also be considered as being noted, where terminology is foreseen as rendering the ability to separate or combine is unclear.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

The foregoing description of illustrated embodiments of the present invention, including what is described in the Abstract, is not intended to be exhaustive or to limit the invention to the precise forms disclosed herein. While specific embodiments of, and examples for, the invention are described herein for illustrative purposes only, various equivalent modifications are possible within the spirit and scope of the present invention, as those skilled in the relevant art will recognize and appreciate. As indicated, these modifications may be made to the present invention in light of the foregoing description of illustrated embodiments of the present invention and are to be included within the spirit and scope of the present invention.

Thus, while the present invention has been described herein with reference to particular embodiments thereof, a latitude of modification, various changes and substitutions are intended in the foregoing disclosures, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the present invention. It is intended that the invention not be limited to the particular terms used in following claims and/or to the particular embodiment disclosed as the best mode contemplated for carrying out this invention, but that the invention will include any and all embodiments and equivalents falling within the scope of the appended claims.

What is claimed is:

1. A method for issuing coupons for a campaign comprising:
entering coupon-issuing information into exposed fields;
determining that the fields have specified information; and
issuing coupons based on the coupon-issuing information specified in the fields.

2. The method of claim 1 additionally comprising creating a campaign.

3. The method of claim 1 additionally comprising determining a role of a person requesting the issuing of coupons.

4. The method of claim 1 wherein said coupon-issuing information comprises one or more information selected from the group consisting of agent ID, reason for issuing coupons, issue date, order number, and E-mail address of person to whom agent issued coupon.

5. The method of claim 1 additionally comprising re-issuing coupons.

6. The method of claim 1 additionally comprising determining if the coupons are available for a campaign.

7. The method of claim 6 additionally comprising recording a coupon-issuing entry into a database.

8. The method of claim 1 additionally comprising returning a coupon code.

9. The method of claim 8 additionally comprising returning a coupon description.

10. The method of claim 1 additionally comprising creating a base coupon.

11. The method of claim 2 wherein said creating a campaign comprises determining that a type of distribution for at least one product is a gift with purchase type of distribution, specifying an identification for the product, and specifying a priority for the product for creating a campaign for the product.

12. The method of claim 11 additionally comprising specifying a campaign name for the product prior to determining the type of distribution for the product.

13. The method of claim 11 additionally comprising creating a base coupon.

14. The method of claim 11 additionally comprising tagging the product.

15. The method of claim 13 additionally comprising replicating the base coupon.

16. The method of claim 13 additionally comprising invalidating the campaign.

17. The method of claim 11 additionally comprising specifying a campaign name for the product.

18. The method of claim 14 wherein said tagging the product comprises selecting a product type, specifying a price range limit on the product, specifying that the product is a storewide product or a category wise product, determining if the product is an online product, and determining if the campaign applies to bundle.

19. The method of claim 15 wherein said replicating a base coupon comprises specifying the campaign name, and specifying the number of coupons to be replicated.

20. The method of claim 16 wherein said invalidating the campaign comprises specifying the name of the campaign for invalidation, and determining if the issued coupons are successfully turned off-line.

21. The method of claim 2 wherein said creating a campaign comprises specifying information in exposed fields, determining that all fields have specified information, determining a type of distribution for a product, and
creating a campaign based on the information specified in the fields.

22. The method of claim 21 wherein the type of distribution is one selected from the group consisting of a third party type of distribution, a customer satisfaction type of distribution, and a gift with purchase type of distribution.

23. The method of claim 21 wherein said type of distribution includes a gift with purchase type of distribution.

24. The method of claim 23 additionally comprising determining if a product ID has been assigned to a product ID field, and determining if a priority has been assigned to a priority field.

25. The method of claim 21 additionally comprising determining if the campaign was properly created.

26. A system for issuing coupons for a campaign comprising:
means for receiving coupon-issuing information into exposed fields;
means for determining that the fields have specified information;
means for issuing coupons based on the coupon-issuing information specified in the fields.

27. A computer-readable storage medium storing program code for causing a computer to perform the steps of:
receiving coupon-issuing information into exposed fields;
determining that the fields have specified coupon-issuing information; and
issuing coupons based on the coupon-issuing information specified in the fields.
